(19) United States
(12) Patent Application Publication
(10) Pub. No.: US 2012/0078821 A1
(43) Pub. Date: Mar. 29, 2012

(54) METHODS FOR UNSUPERVISED LEARNING USING OPTIONAL PÓLYA TREE AND BAYESIAN INFERENCE

(75) Inventors: Li Ma, Stanford, CA (US); Wing H. Wong, Stanford, CA (US)

(73) Assignee: The Board of Trustees of the Leland Srandford Junior University, Palo Alto, CA (US)

(21) Appl. No.: 12/890,641

(22) Filed: Sep. 25, 2010

(51) Int. Cl. G06F 15/18

(52) U.S. Cl. 706/12

(57) ABSTRACT

The present disclosure describes an extension of the Pólya Tree approach for constructing distributions on the space of probability measures. By using optional stopping and optional choice of splitting variables, the present invention gives rise to random measures that are absolutely continuous with piecewise smooth densities on partitions that can adapt to fit the data. The resulting optional Pólya tree distribution has large support in total variation topology, and yields posterior distributions that are also optional Pólya trees with computable parameter values.

### FIELD OF THE INVENTION

The present invention relates to the field of machine learning. More particularly, the present invention provides methods and techniques for improved unsupervised learning and density estimation.

### BACKGROUND OF THE INVENTION

In recent years, machine-learning approaches for data analysis have been widely explored for recognizing patterns which, in turn, allow extraction of significant features within a large amount of data that often contains irrelevant detail. Learning machines comprise algorithms that may be trained to generalize. Trained learning machine algorithms may then be applied to predict the outcome in cases of unknown outcome. Machine-learning approaches, which include neural networks, hidden Markov models, belief networks, support vector and other kernel-based machines, are suited for domains characterized by the existence of large amounts of data, noisy patterns and the absence of general theories.

Statistical learning problems may be categorized as supervised or unsupervised. In supervised learning, a goal is to predict an output based on a number of input factors or variables where a prediction rule is learned from a set of examples (referred to as training examples) each showing the output for a respective combination of variables. In unsupervised learning, the goal is to describe associations and patterns among a set of variables without the guidance of a specific output. An output may be predicted after the associations and patterns have been determined.

The examples shown in FIGS. 1A and 1B are helpful in understanding supervised and unsupervised learning. Shown in FIGS. 1A and 1B are various data points for a sample's height 102 and weight 104.

Shown in FIG. 1A is an example of unsupervised learning. In unsupervised learning. For the data of FIG. 1A only height and weight data are provided to the machine learning algorithm without additional information (e.g., labels). It is, therefore, up to the machine learning algorithm to discern patterns in the data. For example, a machine learning algorithm may attempt to cluster the data and determine decision boundaries 110 and 112 that separate the data. The machine learning algorithm, therefore, determines that the data in Group 106 are highly similar; likewise, the data in Group 108 are highly similar. But the data in Groups 106 and 108 are dissimilar. As new data points become available, they can likewise be categorized into Group 106 or 108

Unsupervised learning has been applied to so-called data mining applications so as to determine the organization of inputted data. Unsupervised learning is closely related to the problem of density estimation in statistics. But unsupervised learning also encompasses many other techniques that seek to summarize and explain key features of the data.

Two classes have been suggested for unsupervised learning. Density estimation techniques explicitly build statistical models (such as Bayesian networks) of how underlying causes could create the input. Feature extraction techniques attempt to extract statistical regularities (or sometimes irregularities) directly from the inputs.

Note, however, that in the present application density estimation is not restricted to the estimation of density of continuous variables but also includes the estimation of relative frequencies in a contingency table. As will be shown, this is because in the special case when there are k discrete variables, the joint density of the variables, with respect to a counting measure on the product space of spaces for the individual discrete variable, is exactly the same as the relative frequency function that is defined on the cells of the corresponding contingency table. This will be further explained in further below.

The larger class of unsupervised learning methods consists of maximum likelihood (ML) density estimation methods. These are based on building parameterized models of the probability distribution, where the forms of the models (and possibly prior distributions over the parameters) are constrained by a priori information in the form of the representational goals. These are called synthetic or generative models because they specify how to synthesize or generate samples.

One form of unsupervised learning is clustering. Another example is blind source separation based on Independent Component Analysis (ICA). Among neural network models, the Self-organizing map (SOM) and Adaptive resonance theory (ART) are commonly used unsupervised learning algorithms.

The SOM is a topographic organization in which nearby locations in the map represent inputs with similar properties. The ART model allows the number of clusters to vary with problem size and lets the user control the degree of similarity between members of the same clusters by means of a user-defined constant called the vigilance parameter. ART networks are also used for many pattern recognition tasks, such as automatic target recognition and seismic signal processing.

Supervised learning is shown in FIG. 1B. In the situation of FIG. 1B additional label information is input to the machine learning algorithm. As shown in FIG. 1B, the height and weight combination of data points are provided with a label of European 150 (shown in empty circles) or Asian 152 (shown in filled circles). With the additional label information available as training data, the machine learning algorithm is able to provide a decision boundary 154 that predicts whether a set of data is one label or another.

In general, statistical learning involves finding a statistical model that explains the observed data that may be used to analyze new data, e.g., learning a weighted combination of numerical variables from labeled training data to predict a class or classification for a new combination of variables. Determining a model to predict quantitative outputs (continuous variables) is often referred to as regression. Determining a model to predict qualitative data (discrete categories, such as ‘yes’ or ‘no’) is often referred to as classification.

Bayesian inference is a principal approach to statistical learning. When Bayesian inference is applied to the learning of a probability distribution, one needs to start with the construction of a prior distribution on the space of probability distributions. Ferguson [Ferg73] formulated two criteria for desirable prior distributions on the space of probability distributions: (i) the support of the prior should be large with respect to a suitable topology and (ii) the corresponding posterior distribution should be analytically manageable. (Note that various references will be cited in the form [refYY] where “ref” is a shorthand notation for the author and “YY” is a shorthand notation for the year. The full citations are included at the end of the present specification. Each reference is herein incorporated by reference for all purposes.) Extending the work by Freedman [Free63] and Fabius [Fabius64], he introduced the Dirichlet process as a prior that satisfies these criteria. Specifically, assuming for simplicity that the parameter space Ω is a bounded interval of real numbers and the base measure in the Dirichlet process prior is the Lebesgue measure, then the prior will have positive probability in all weak neighborhoods of any absolutely continuous probability measure, and given independent identically distributed observations, the posterior distribution is also a Dirichlet process with its base measure obtainable from that of the prior by the addition of delta masses at the observed data points. An important property of the approach of Ferguson and Freeman is that it does not require parametric assumptions on the probability distribution to be inferred. Methods with this property are called Bayesian nonparametric methods.

While these properties made it an attractive prior in many Bayesian nonparametric problems, the use of the Dirichlet process prior is limited by its inability to generate absolutely continuous distributions for continuous variables. For example, a random probability measure sampled from the Dirichlet process prior is almost surely a discrete measure [Black73, BlackMac73, Ferg73] which does not posses a density function. Thus in applications that require the existence of densities under the prior, such as the estimation of a density from a sample [Lo84] or the modeling of error distributions in location or regression problems [Dia86], there is a need for alternative ways to specify the prior.

Lo [Lo84] proposed an prior in the space of densities by assuming the density is a mixture of kernel functions where the mixing distribution is modeled by a Dirichlet process. Under Lo's model, the random distributions are guaranteed to have smooth densities and the predictive density is still analytically tractable, but the degree of smoothness is not adaptive.

Another approach to deal with the discreteness problem was to use Pólya tree priors [Ferg74]. This class of random probability measures includes the Dirichlet process as a special case and is itself a special case of the more general class of “tail free” processes previously studied by Freedman [Free63].

Pólya tree prior satisfies Ferguson's two criteria. First, it is possible to construct Pólya tree priors with positive probability in neighborhoods around arbitrary positive densities [Lav92]. Second, the posterior distribution arising from a Pólya tree prior is available in close form [Ferg74]. Further properties and applications of Pólya tree priors are found in [Mau192], [Lav94], [Ghosh03], [Hans06], and [Hutter09]. But these properties only hold when the smoothness on the resulting distribution is not data-adaptive.

The idea of early stopping in a Pólya tree was discussed by Hutter [Hutter09]. Ways to attenuate the dependency of Pólya tree on the partition include mixing the base measure used to define the tree [Lav92, Lav94, Hans06], random perturbation of the dividing boundary in the partition of intervals [Paddock03], and the use of positively correlated variables for the conditional probabilities at each level of the tree definition [Nie09].

Compared to these works, the present invention, which extends the Pólya tree approach, allows not only early stopping but also randomized choices of the splitting variables. Early stopping results in density functions that are piece-wise constant on a partition. Random choice of splitting variables allows the construction of a much richer class of partitions than previous models and raises a new challenge of learning the partition based on the observed data. In the disclosure of the present invention, it is shown that under mild conditions such learning is achievable by finite computation. The present invention provides a comprehensive mathematical foundation including the theory for Bayesian density estimation based on recursive partitioning.

Although a Bayesian version of recursive partitioning has been proposed previously (Bayesian CART, [Denison98]), it was formulated for a different problem (classification instead of density estimation). Furthermore, it studied mainly model specification and computational algorithm and did not discuss the mathematical and asymptotic properties of the method.

### SUMMARY OF THE INVENTION

The present invention includes an extension of the Pólya tree prior construction by allowing optional stopping and randomized partitioning schemes. Regarding optional stopping, the present invention considers the standard construction of Pólya tree prior for probability measures in an interval Ω. The interval is recursively bisected into subintervals. At each stage, the probability mass already assigned to an interval is randomly divided and assigned into its subintervals according to the independent draw of a Beta variable. But in order for the prior to generate absolutely continuous measures, it is necessary for the parameters in the Beta distribution to increase rapidly as the depth of the bisection increases, for example, as the bisection moves into more and more refined levels of partitioning [Kraft64].

Even when the construction yields a random distribution with density with probability 1, the density will have discontinuity almost everywhere. The use of Beta variables with large magnitudes for its parameters, although useful in forcing the random distribution to be absolutely continuous, has the effect of constraining the ability to allocate conditional probability to represent the data distributions within small intervals.

To resolve the conflict between smoothness and faithfulness to the data distribution, the present invention introduces an optional stopping variable for each subregion obtained in the partitioning process [Hutter09]. By putting uniform distributions within each stopped subregion, the present invention achieves the goal of generating absolutely continuous distributions without having to force the Beta parameters to increase rapidly.

The present invention is able to implement Jeffrey's rule of Beta (1/2,1/2) in the inference of conditional probabilities, regardless of the depth of the subregion in the partition tree that is understood to be a desirable consequence of optional stopping.

A second extension of the present invention is to allow randomized partitioning. Standard Pólya tree construction relies on a fixed scheme for partitioning. For example in [Hans06], a k-dimensional rectangle is recursively partitioned where in each stage of the recursion, the subregions are further divided into 2^{k} quadrants by bisecting each of the k coordinate variables. In contrast, when recursive partitioning is used in other statistical problems, it is customary to allow flexible choices of the variables to use to further divide a subregion. This allows the subregion to take very different shapes depending on the information in the data.

The data-adaptive nature of the recursive partitioning is a reason for the success of tree-based learning methodologies such as CART [Brei84]. It is, therefore, desirable to allow Pólya tree priors to use partitions that are the result of randomized choices of divisions in each of the subregions at each stage of the recursion. Once the partitioning is randomized in the prior, the posterior distribution will give more weight to those partitions that provide better fits to the data. In this way the data is allowed to influence the choice of the partitioning. This is especially useful in high dimensional applications.

The present invention introduces the construction of optional Pólya trees that allow optional stopping and randomized partitioning. It is shown that this construction leads to priors that generally provide continuous distributions. In the disclosure of the present invention, it is shown how to specify the prior so that it has positive probability in all total variation neighborhoods in the space of absolutely continuous distributions on Ω.

The disclosure of the present invention also shows that the use of optional Pólya tree priors will lead to posterior distributions that are also optional Pólya trees. A recursive algorithm is presented for the computation of the parameters governing the posterior optional Pólya tree. These results ensure that Ferguson's two criteria are satisfied by optional Pólya tree priors, but now on the space of absolutely continuous probability measures.

The disclosure of the present invention also shows that the posterior Pólya tree is weakly consistent in the sense that asymptotically it concentrates all its probability in any weak neighborhood of a true distribution whose density is bounded.

In the present disclosure, the optional Pólya tree approach of the present invention is tested against density estimation in Euclidean space to demonstrate its utility.

### BRIEF DESCRIPTION OF THE DRAWINGS

The following drawings will be used to more fully describe embodiments of the present invention.

FIGS. 1A and B provide an example of supervised and unsupervised machine learning techniques.

FIGS. 2A-C show the density estimation results for a mixture of uniform distributions for three implementations of the present invention with a sample size of 100.

FIGS. 3A-C show the density estimation results for a mixture of uniform distributions for three implementations of the present invention with a sample size of 500.

FIGS. 4A-C show the density estimation results for a mixture of uniform distributions for three implementations of the present invention with a sample size of 2500.

FIGS. 5A-C show the density estimation results for a mixture of uniform distributions for three implementations of the present invention with a sample size of 12,500.

FIGS. 6A-C show the density estimation results for a mixture of uniform distributions for three implementations of the present invention with a sample size of 100,000.

FIGS. 7A-C show the density estimation results for a mixture of two Beta distributions for three implementations of the present invention with a sample size of 100.

FIGS. 8A-C show the density estimation results for a mixture of two Beta distributions for three implementations of the present invention with a sample size of 500.

FIGS. 9A-C show the density estimation results for a mixture of two Beta distributions for three implementations of the present invention with a sample size of 2500.

FIGS. 10A-C show the density estimation results for a mixture of two Beta distributions for three implementations of the present invention with a sample size of 12,500.

FIGS. 11A-C show the density estimation results for a mixture of two Beta distributions for three implementations of the present invention with a sample size of 100,000.

FIGS. 12A-D show the density estimates for a mixture of uniform and “semi-Beta” using the posterior mean approach for an optional Pólya tree with the restriction of “alternate cutting” and using a sample size of 100, 500, 1000, and 5000, respectively.

FIGS. 13A-D show the density estimates for a mixture of uniform and “semi-Beta” by the hierarchical MAP method using the posterior mean approach for an optional Pólya tree with the restriction of “alternate cutting” and using a sample size of 100, 500, 1000, and 5000, respectively.

FIGS. 14A-D show the density estimates for a mixture of uniform and “semi-Beta” by the hierarchical MAP method using an optional Pólya tree prior with no restriction on division and using a sample size of 100, 500, 1000, and 5000, respectively.

FIGS. 15A-D show the density estimates for a mixture of uniform and “semi-Beta” by the hierarchical MAP method using an optional Pólya tree prior applied to samples from a bivariate normal distribution BN((0.4, 0.6), 0.1²I) and using a sample size of 500, 1000, 5000, and 10,000, respectively.

FIGS. 16a-c examples of partitioning according to the present invention.

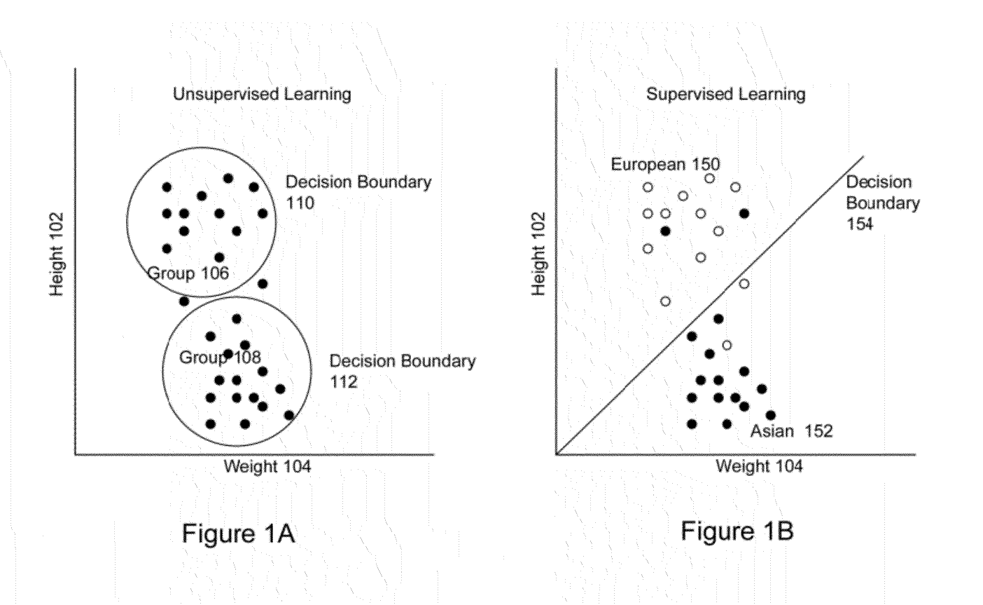

### DETAILED DESCRIPTION OF THE INVENTION

The present disclosure relates to methods, techniques, and algorithms for machine learning that are intended to be implemented in a digital computer. Such a digital computer is well-known in the art and may include the following: at least one central processing unit, memory in different forms (e.g., RAM, ROM, hard disk, optical drives, removable drives, etc.), drive controllers, at least one display unit, video hardware, a pointing device (e.g., mouse), a text input device (e.g., keyboard), peripherals (e.g., printer), communications interfaces (e.g., LAN network adapter, WAN network adapter, modem, etc.), an input/output bus, and bus controller. It is expected that computer technology will continue to advance but one of ordinary skill in the art will be able to take the present disclosure and implement the described teachings on the more advanced computers as they become available. Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

Moreover, the present disclosure provides a detailed explanation of the present invention with detailed formulas and explanations that allow one of ordinary skill in the art to implement the present invention into a computer learning method. For example, the present disclosure provides detailed indexing schemes that readily lend themselves to multi-dimensional arrays for storing and manipulating data in a computerized implementation. Certain of these and other details are not included in the present disclosure so as not to detract from the teachings presented herein but it is understood that one of ordinary skill in the at would be familiar with such details.

The present invention relates to constructing random probability measures on a space (Ω,μ). Ω is either finite or a bounded rectangle in R^{p}. For simplicity, assume that μ is the counting measure in the finite case and the Lebesgue measure in the continuous case. Suppose that Ω can be partitioned in M different ways, i.e., for j=1, 2, . . . , M,

Ω=∪ₖ₌₁^{K}^{ⱼ}Ωₖ^{j} where Ωₖ^{j}'s are disjoint.

Each Ωₖ^{j}, called a level-1 elementary region, can in turn be divided into level-2 elementary regions. Assume there are Mₖ₁^{j}₁ ways to divide Ωₖ₁^{j}₁, then for j₂=1, . . . , Mₖ₁^{j}₁, we have

Ωₖ₁^{j}₁=∪ₖ₂₌₁^{K}ₖ₁^{j}₁^{j}₂Ωₖ₁ₖ₂^{j}₁^{j}₂.

In general, for any level-k elementary region A, we assume there are M(A) ways to partition it, i.e., for j=1, 2, . . . , M(A),

A=∪ₖ₌₁^{K}^{ⱼ}^{(A)}Aₖ^{j}.

Let [symbol] ^{k} be the set of all possible level-k elementary regions, and [symbol] ^{(k)}=∪ₗ₌₁^{k} [symbol] ^{l}. If Ω is finite, we assume that [symbol] ^{k} separates points in Ω if k is large enough. If Ω is a rectangle in R^{p}, we assume that every open set B⊂Ω is approximated by unions of sets in [symbol] ⁽ⁿ⁾, i.e., ┌Bₙ⇑B where Bₙ is a finite union of disjoint regions in [symbol] ⁽ⁿ⁾.

Consider the following example (Example 1):

Ω==(x₁, . . . , xₚ):xᵢε{1,2}}

Ωₖ^{j}={x:xⱼ=k}, k=1 or 2

Ωₖ₁ₖ₂^{j}₁^{j}₂=x:xⱼ₁=k₁,xⱼ₂=k₂}, etc.

In this example, the number of ways to partition a level-k elementary region decreases as k increases.

Now consider the following example (Example 2):

Ω={(xⱼ,x₂, . . . , xₚ):xᵢε[0,1]}⊂R^{p}

If A is a level-k elementary region (a rectangle) and mⱼ(A) is the midpoint of the range of xⱼ for A, we set A₁^{j}={xεA:xⱼ≦mⱼ(A)} and A₂^{j}=A\A₁^{j}. There are exactly M(A)=p ways to partition each A, regardless of its level.

Once a system to generate partitions has been specified as above, recursive partitions can be defined as follows. A recursive partition of depth k is a series of decisions J^{(k)}=(J₁, J₂, . . . , Jₖ) where Jₗ represents all the decisions made at level l to decide, for each region produced at the previous level, whether or not to stop partitioning it further and if not, which way to use to partition it. Once it is determined not to partition a region, then it will remain intact at all subsequent levels. Thus, each J^{(k)} specifies a partition of Ω into a subset of regions in [symbol] ^{(k)}.

A recursive procedure is used to produce a random recursive partition of Ω and a random probability measure Q that is uniformly distributed within each part of the partition. Suppose after k steps of the recursion, a random recursive partition J^{(k)} is obtained and represented as

Ω=T₀^{k}∪T₁^{k}

where
T₀k=∪ᵢ₌₁^{I}Aᵢ is a union of disjoint Aᵢε [symbol] ^{(k-1)}
T₁^{k}=∪ᵢ₌₁^{I′}A′ᵢ is a union of disjoint A′ᵢε [symbol] ^{k}.
   The set T₀ represents the part of Ω where the partitioning has already been stopped and T₁ represents the complement. In addition, a random probability measure Q^{(k)} on Ω which is uniformly distributed within each region in T₀^{k} and T₁^{k} is also obtained.

In the (k+1)th step, Q^{(k+1)} is defined by further partitioning of the regions in T₁^{k} as follows. For each elementary region A in the above decomposition of T₁^{k}, an independent random variable is generated

S˜Bernoulli( [symbol] ).

If S=1, stop further partitioning of A and add it to the set of stopped regions. If S=0, draw Jε{1, 2, . . . , M(A)} according to a non-random vector λ(A)=(λ₁, . . . , λ_{M(A)}), called the selection probability vector, i.e., P(J=j)=λⱼ and Σₗ₌₁^{M(A)}λₗ=1. If J=j, apply the jth way of partitioning A,

A=∪ₗ₌₁^{K}Aₗ^{j} (here K depends on A and j)

and set Q^{(k+1)}(Aₗ^{j})=Q^{(k)(A)Θ}ₗ^{j} where Θ^{j}=(Θ₁^{j}, . . . , Θ_{K}^{j}) is generated from a Dirichlet distribution with parameter (α₁^{j}, . . . , α_{K}^{j}). The non-random vector α^{j}=α^{j}(A) is referred to as the assignment weight vector.

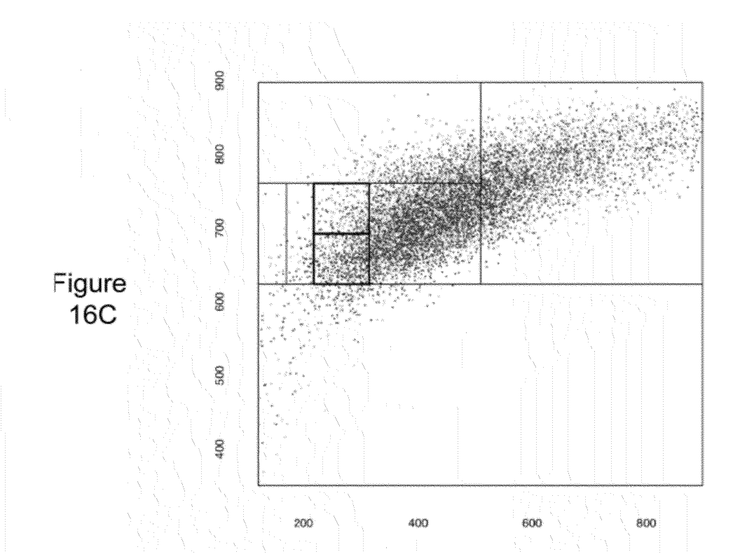

An example of this partitioning scheme is shown in FIGS. 16A and B. As shown in FIG. 16A, the partitioning technique has proceeded to the point where partition A 102 is to be considered. Shown in FIG. 16B are the various scenarios. In condition 1604, the stopping variable, S, is 1 and further partitioning ceases. Accordingly, partition A 102 is not further partitioned. In condition 1606, the stopping variable, S, is set to 0 and further partitioning is to be performed. In this condition, there are two choices for partitioning—condition 1608 with J=1 and condition 1610 with J=2. Condition 1608 creates a vertical division yielding partitions A₁¹ 1616 and A₂¹ 1618. Condition 1610 creates a horizontal division yielding partitions A₁² 1620 and A₂² 1622. Shown in FIG. 16C is an example of the manner in which partitioning could be implemented in a two-dimensional flow cytometry example.

Continuing, T₀^{k+1} and T₁^{k+1}, the respective unions of the stopped and continuing regions, is obtained. Clearly,

Ω=T₀^{k+1}∪T₁^{k+1}

T₀^{k+1}⊃T₀^{k},T₁^{k+1}⊂T₁^{k}.

The new measure Q^{(k+1)} is then defined as a refinement of Q^{(k)}. For B⊂T₀^{(k+1)},

Q^{(k+1)}(B)=Q^{(k)}(B)

is set. For B⊂T₁^{(k+1)} where T₁^{k+1} is partitioned as

T₁^{k+1}=∪ᵢ₌₁^{J}Aᵢ,Aᵢε [symbol] ^{k+1},

Q^{(k+1)}(B)=Σᵢ₌₁^{J}Q^{(k+1)}(Aᵢ)(μ(Aᵢ∩B)/μ(Aᵢ)).

is set. Recall that for each Aᵢ in the partition of T₁^{k+1}, we have already generated its Q^{(k+1)} probability.

Let [symbol] ^{(k)} be the σ-field of events generated by all random variables used in the first k steps; the stopping probability [symbol] = [symbol] (A) is required to be measurable with respect to [symbol] ^{(k)}. The specification of [symbol] (•) is called the stopping rule.

Among other things, the present invention addresses the case when [symbol] (•) is an “independent stopping rule”, e.g., [symbol] (A) is a pre-specified constant for each possible elementary region A. In some applications, however, it is useful to let [symbol] (A) depend on Q^{(k)}(A).

Consider now, the following theorem (Theorem 1). Let [symbol] ^{(∞)}=∪ₖ₌₁^{∞} [symbol] ^{k} be the set of all possible elementary regions. Suppose there is a δ>0 such that with probability 1, 1−δ> [symbol] (A)>δ for any region A generated during any step in the recursive partitioning process. Then with probability 1, Q^{(k)} converges in variational distance to a probability measure Q that is absolutely continuous with respect to μ.

The random probability measure Q defined in Theorem 1 is said to have an optional Pólya tree distribution with parameters λ, α and stopping rule [symbol] .

The following is a proof of Theorem 1. Only the case when Ω is a bounded rectangle is the proof necessary. Q^{(k)}'s can be thought of as being generated in two steps.
1. Generate the non-stopped version Q*(k) by recursively choosing the ways of partitioning each level of regions, but without stopping in any of the regions. Let J*^{(k)} denote the decision made during this process in the first k levels of the recursion. Each realization of determines a partition of Ω consisting of regions Aε [symbol] k (not [symbol] ^{(k)} as in the case of optional stopping). Let [symbol] ^{k}(J*^{(k)})={Aε [symbol] ^{k}:A is a region in the partition induced by J*^{(k)}}. If Aε [symbol] ^{k}(J*^{(k)}), then it can be written as

A=Ω_{l1l2 . . . lk}^{j}₁^{j}₂^{. . . j}ₖ.
We set

Q*^{(k)}(A)=Θₗ₁^{j}₁·Θₗ₁ₗ₂^{j}₁^{j}₂· . . . ·Θ_{l1 . . . lk}^{j}₁^{. . . j}ₖ and Q*^{(k)}(•|A)=μ(•|A)
This defines Q*^{(k)} as a random measure.
2. Given the results in Step 1, generate the optional stopping variables S=S(A) for each region Aε [symbol] ^{k}(J*^{(k)}), successively for each level k=1, 2, 3, . . . . Then for each k, modify Q*^{(k)} to get Q^{(k)} by replacing Q*^{(k)}(•|A) with μ(•|A) for any stopped region A up to level k.

For each Aε [symbol] ^{k}(J*^{(k)}), let I^{k}(A)=indicator of the event that A has not been stopped during the first k levels of the recursion.

$$\begin{matrix}E ( {Q}^{( k )} ( {T}_{1}^{k} ) \vert {J}^{* ( k )} ) = E ( {\sum }_{a ∈ {𝒜}^{k} ( {J}^{* ( k )} )} {Q}^{* ( k )} ( A ) {I}^{k} ( A ) \vert {J}^{* ( k )} ) \\ = {\sum }_{A ∈ {𝒜}^{k} ( {J}^{* ( k )} )} E ( {Q}^{* ( k )} ( A ) \vert {J}^{* ( k )} ) E ( {I}^{k} ( A ) \vert {J}^{* ( k )} ) \leq \\ {( 1 - δ )}^{k} {\sum }_{a ∈ {𝒜}^{k} ( {J}^{* ( k )} )} E ( {Q}^{* ( k )} ( A ) \vert {J}^{* ( k )} ) \\ = {( 1 - δ )}^{k} .\end{matrix}$$

Thus E(Q^{(k)}(T₁^{k}))→>0 geometrically and hence Q^{(k)}(T₁^{k})→0 with probability 1. Similarly, μ(T₁^{k})→0 with probability 1.

For any Borel set B⊂SΩ, lim Q^{(k)}(B) exists with probability 1. To see this, write

$$\begin{matrix}{Q}^{( k )} ( B ) = {Q}^{( k )} ( B ⋂ {T}_{0}^{k} ) + {Q}^{( k )} ( B ⋂ {T}_{1}^{k} ) \\ = {a}_{k} + {b}_{k} ;\end{matrix}$$

aₖ is increasing since

$${Q}^{( k + 1 )} ( B ⋂ {T}_{0}^{k + 1} ) \geq {Q}^{( k - 1 )} ( B ⋂ {T}_{o}^{k} ) = {Q}^{( k )} ( B ⋂ {T}_{0}^{k} )$$

and bₖ→0 since Q^{(k)}(T₁^{k})→0 with probability 1.

Since the Borel ν-field [symbol] is generated by countably many rectangles, we have with probability 1 that lim Q^{(k)}(B) exists for all Bε [symbol] . Define Q(B) as this limit. If Q(B)>0 then Q^{(k)}(B)>0 for some k. Since Q^{(k)}<<μμ by construction, we must also have μ(B)>0. Thus Q is absolutely continuous.

For any Bε [symbol] , Q^{(k)}(B∩T₀^{k})=Q(B∩T₀^{k}), and hence

$$\vert {Q}^{( k )} ( B ) - Q ( B ) \vert = \vert {Q}^{( k )} ( B ⋂ {T}_{1}^{k} ) - Q ( B ⋂ {T}_{1}^{k} ) \vert < 2 {Q}^{( k )} ( {T}_{1}^{k} ) 0 \; 0.$$

Thus the convergence of Q^{(k)} to Q is in variational distance and the proof of Theorem 1 is complete.

The next theorem (Theorom 2) shows that it is possible to construct an optional Pólya tree distribution with positive probability on all L₁ neighborhoods of densities. Let Ω be a bounded rectangle in RP. Suppose that the condition of Theorem 1 holds and that the selection probabilities λᵢ(A), the assignment probabilities αᵢ^{j}(A)/(Σ₁α₁^{j}(A)) for all i,j and Aε [symbol] ^{(∞)}, are uniformly bounded away from 0 and 1. Let q=dQ/dμ, then for any density f and any τ>0,

P(∫|q(x)−ƒ(x)|dμ<τ)>0.

The proof of Theorem 2 is as follows. First assume that ƒ is uniformly continuous. Let

ε(∈)=sup_{|x-y|<∈}|ƒ(x)−ƒ(y)|

then δ(∈)↓0 as ∈↓0. For any k large enough, we can find a partitioning Ω=Uᵢ₌₁^{I}Aᵢ where Aᵢε [symbol] ^{k} is arrived at by k steps of recursive partitioning (deterministic and without stopping) and that each Aᵢ has diameter <∈.

Approximate ƒ by a step function ƒ(x)=Σᵢƒᵢ*I_{Ai}(x),ƒᵢ*=∫_{Ai}ƒdμ/μ(Aᵢ). Let D_{∈}(ƒ) be the set of step functions g(•)=ΣgᵢI_{Ai}(•) satisfying

supᵢ|gᵢ−ƒᵢ*|<δ(∈).

Suppose gεD_{∈}(ƒ), then for any B we have B=∪ᵢ₌₁^{I}(B∩Aᵢ)=Uᵢ₌₁^{I}Bᵢ and

|∫_{B}(g−ƒ)dμ|≦Σᵢ|gᵢ−ƒᵢ*|μ(Bᵢ)+Σᵢ|ƒᵢ*μ(Bᵢ_−∫_{Bi}ƒdμ|

≦Σᵢδ(∈)μ(Bᵢ)+Σᵢrᵢ,

where

$$\begin{matrix}{r}_{i} = μ ( {B}_{i} ) \vert {\int }_{Ai} f d μ / μ ( {A}_{i} ) - {\int }_{Bi} f d μ / μ ( {B}_{i} ) \vert \\ = μ ( {B}_{i} ) \vert {\int }_{Ai} ( f ( x ) - f ( {x}_{k} ) ) d μ / μ ( {A}_{i} ) - {\int }_{Bi} ( f ( x ) - f ( {x}_{k} ) ) d μ / μ ( {B}_{i} ) \vert\end{matrix}$$

where xᵢεBᵢ. Since

|ƒ(x)−ƒ(xᵢ)|<δ(∈) for xεAᵢ,

we have

|rᵢ|<2δ(∈)μ(Bᵢ).

### Hence

|∫_{B}(g−ƒ)dμ|<3δ(∈)μ(B)∀B

and thus

∫|g−ƒ|dμ<3δ(∈)μ(Ω)=3δ′(∈),

where δ′(∈)=δ(∈)μ(Ω). Since all probabilities in the construction of q^{k}=dQ^{(k)}/dμ, are bounded away from 0 and 1, we have

P(q^{k}εD_{∈}(ƒ) for all large k)>0.

### Hence

P(∫|q^{k}—ƒ|dμ<δ′(∈) for all large k)>0.

On the other hand, by Theorem 1, we have

P(∫|q^{k}−q|dμ→0)=1.

### Thus

P(∫|q−ƒ|dμ<<4δ′(∈))>0.

Finally, the result also holds for a discontinuous ƒ since we can approximate it arbitrarily closely in L₁ distance by a uniformly continuous one and the proof of Theorem 2 is complete.

It is not difficult to specify αᵢ^{j}(A) to satisfy the assumption of Theorem 2. A useful choice is

αᵢ^{j}(A)=τ^{k}μ(Aᵢ^{j})/μ(Ω) for Aε [symbol] ^{k},

where τ>0 is a suitable constant.

The reason for including the factor τ^{k} when Aε [symbol] ^{k} is to ensure that the strength of information specified for the conditional probabilities within A is not diminishing as the depth of partition k increases. For example in Example 2 above, each A is partitioned into two parts of equal volumes,

A=A₁^{j}∪A₂^{j},μ(A₁^{j})=μ(A₂^{j})=½μ(A).

Thus, Aε [symbol] ^{k} [symbol] μ(Aᵢ^{j})=^{-(k+1)}μ(Ω), and

αᵢ^{j}(A)=2^{k}μ(Aᵢ^{j})/μ(Ω)=½ for all k.

In this case, by choosing τ=2, a nice “self-similarity” property is obtained for the optional Pólya tree, in the sense that the conditional probability measure Q(•|A) will have an optional Pólya tree distribution with the same specification for αᵢ^{j}'s as in the original optional Pólya tree distribution for Q.

Furthermore, in this example if τ=2 is used to specify a prior distribution for Bayesian inference of Q, then for any Aε [symbol] ^{k}, the inference for the conditional probability Θ₁^{j}(A) will follow a classical binomial Bayesian inference with the Jeffrey's prior Beta (1/2,1/2).

In the context of the present invention, Bayesian inference with an optional Pólya tree prior is now considered. Suppose x={x₁, x₂, . . . , xₙ} are observed where xᵢ's are independent draws from a probability measure Q, where Q is assumed to have an optional Pólya tree as a prior distribution. The present disclosure will show that the posterior distribution of Q given x also follows an optional Pólya tree distribution.

The prior distribution for q=dQ/dμ is denoted by π(•). For any A⊂Ω, we define x(A)={xᵢεx:xᵢεA} and n(A)=#(x(A))=cardinality of the set x(A). Let

q(x)=dQ/dμ(x) for xεΩ

and q(x|A)=q(x)/Q(A) for xεA,

then the likelihood for x and the marginal density for x can be written respectively as

P(x|Q)=Πᵢ₌₁ⁿq(xᵢ)=q(x)

P(x)=∫q(x)dπ(q).

The variable q (or Q) represents the whole set of random variables, i.e., the stopping variable S(A), the selection variable J(A) and the condition probability allocation Θᵢ^{j}(A), etc., for all regions A generated during the generation of the random probability measure Q.

In what follows, it is assumed that the stopping rule needed for Q is an independent stopping rule. By considering how Ω is partitioned and how probabilities are assigned to the parts of this partition, we have

q(x)=Su(x)+(1−S)(Πᵢ₌₁^{K}^{_{J}}(Θᵢ^{J})ⁿᵢ^{J})q(x|N^{J}=n^{J}). (1)

In this expression,
(i) u(x)=Πᵢ₌₁ⁿu(xᵢ) where u(x)=1/μ—(Ω) is the uniform density on Ω.
(ii) S=S(Ω) is the stopping variable for Ω.
(iii) J is the choice of partitioning to use on Ω.
(iv) N^{J}=(n(Ω₁^{J}), . . . , n(Ω_{K}^{J}^{^{J}})) is the counts of observations in x falling into each part of the partition J.

To understand q(x|N^{J}=n^{j}), suppose J=j specifies a partition Ω=Ω₁^{j}∪Ω₂^{j}∪ . . . ∪Ω_{K}^{j}^{^{j}}, then the sample x is partitioned accordingly into subsamples

x=x(Ω₁^{j})∪ . . . ∪x(Ω_{K}^{j}^{^{j}}).

Under Q, if the subsample sizes n_{I}^{j}, . . . , n_{K}^{j}^{^{j}} are given, then the positions of points in x(Ωᵢ^{j}) within Ωᵢ^{j} are generated independently of those in the other subregions. Thus

q(x|N^{J}=n^{j})=Πᵢ₌₁^{K}^{ⱼ}q(x(Ωᵢ^{j})|Ωᵢ^{j})

where q(x(Ωᵢ^{j})|Ωᵢ^{j})=Π_{xεx(Ωi}_{^{j}}₎q(x|Ωᵢ^{j}).

Note that once J=j is given, q(•|Ωᵢ^{j}) is generated independently as an optional Pólya tree according to the parameters [symbol] , λ, α that are relevant within Ωᵢ^{j}. Φ(Ωᵢ^{j}) denotes the expectation of q(x(Ωᵢ^{j})|Ωᵢ^{j}) under this induced optional Pólya tree within Ωᵢ^{j}.

In fact, for any A⊂∪ₖ₌₁^{∞} [symbol] ^{k}, optional Pólya tree distribution π_{A}(q) is induced for the conditional density q(•|A), and

Φ(A)=∫q(x(A)|A)dπ_{A}(q)

is defined if x(A)≠Ø and Φ(A)=1 if x(A)=Ø. Similarly,

Φ₀(A)=u(x(A)|A)=Π_{xεx(A)}u(x|A)

is defined and Φ₀(A)=1 if x(A)=Ø. Note that P(x)=Φ(Ω) and u(x)=Φ₀(Ω).

Next, the random variables in the right-hand side of Equation 1 are successively integrated out with respect to π(•) according to the order q(x|n^{J}), Θ^{J}, J, and S (last). This yields

Φ(Ω)= [symbol] Φ₀(Ω)+(1− [symbol] )Σⱼ₌₁^{M}λⱼD(n^{j}+α^{j})/D(α^{j})Πᵢ₊₁^{K}^{ⱼ}Φ(Ωᵢ^{j}) (2)

where D(t)=Γ(t₁) . . . Γ(tₖ)/Γ(t₁+ . . . +tₖ).

Similarly, for any Aε∪ₖ₊₁^{∞} [symbol] ^{k} with x(A)≠Ø,

Φ(A)= [symbol] Φ₀(A)+(1− [symbol] )Σⱼ₌₁^{M}λᵢD(n^{j}+α^{j})/D(α^{j})Πᵢ₌₁^{K}^{ⱼ}Φ(Aᵢ^{j}) (3)

where n^{j} is the vector of counts in the partition [Lupe, in the next expression the intersection symbol should be replaced by the union symbol. Please check all occurrences of this] A=∪ᵢ₌₁^{K}^{ⱼ}Aᵢ^{j}, and M, K^{j}, [symbol] , λ^{j}, α^{j}, etc., all depend on A. It is noted that in the special case when the choice of splitting variables are non-random, a similar recursion was given in [Hutter09].

The posterior distribution of S=S(Ω) from Equation 2 has now been read off by noting that the first term [symbol] Φ₀(Ω) and the remainder in the right-hand side of Equation 2 are respectively the probabilities of the events

{stopped Ω, generate x from u(•)}

and

{not stopped at Ω, generate x by one of the M partitions}

Thus S˜Bernoulli with probability [symbol] Φ₀(Ω)/Φ(Ω). Similarly, the jth term in the sum (over j) appearing in the right-hand side of Equation 2 is the probability of the event

{not stopped at Ω, generate x by using the jth way to partition Ω}.

Hence, conditioning on not stopping at Ω, J takes value j with probability proportional to

λⱼD(n^{j}+α^{j})/D(α^{j})Πᵢ₌₁^{K}^{ⱼ}Φ(Ωᵢ^{j}).

Finally, given J=j, the probabilities assigned to the parts of this partition is Θ^{j} whose posterior distribution is Dirichlet (n^{j}+α^{j}).

By similar reasoning, the posterior distribution of S=S(A), J=J(A), Θ^{j}=Θ^{j}(A) from Equation 3 can also be read off, for any A⊂ [symbol] ^{k}.

Thus, we have proven the following theorem (Theorem 3). Suppose x=(x₁, . . . , xₙ) are independent observations from Q where Q has a prior distribution π(•) that is an optional Pólya tree with independent stopping rule and satisfying the condition of Theorem 2, then the conditional distribution of Q given X=x is also an optional Pólya tree where, for each A⊂A^{∞}, the parameters are given as follows:
1. Stopping probability:

[symbol]

(A|x)= [symbol] (A)Φ₀(A)/Φ(A)
2. Selection probabilities:

P(J=j|x)∝λⱼD(nⱼ+α^{j})/D(α^{j})Πᵢ₌₁^{K}^{ⱼ}Φ(Aᵢ^{j}) j=1, . . . , M
3. Allocation of probability to subregions: the probabilities Θᵢ^{j} for subregion Aᵢ^{j}, i=1, . . . , K^{j} are drawn from Dirichlet (n^{j}+α^{j}).
   In the above, it is understood that M, K^{j}, λⱼ, n^{j}, α^{j} all depend on A.

The notation π(•|x₁, x₂, . . . , xₙ) is used to denote this posterior distribution for Q.

To use Theorem 3, Φ(A) for Aε [symbol] ^{∞} needs to be computed. This is done by using the recursion of Equation 3, which says that Φ(•) is determined for a region A if it is first determined for all subregions Aᵢ^{j}. By going into subregions of increasing levels of depth, regions having certain simple relations with the sample x will be determined. Close form solutions for Φ(•) can be derived for such “terminal regions,” and all the parameters in the specifications of the posterior optional Pólya tree by a finite computation can be determined. Two examples are provided (Examples 3 and 4).

In Example 3, a 2^{p} contingency table is considered. Let Ω={1,2}×{1,2}× . . . ×{1,2} be a table with 2^{p} cells. Let x=(x₁, x₂, . . . , xₙ) be n independent observations, where each xᵢ falls into one of the 2^{p} cells according to the cell probabilities {q(y):yεΩ}. Assume that q has an optional Pólya tree distribution according to the partitioning scheme in Example 1, where λⱼ=1/M if there are M variables still available for further splitting of a region A, and αᵢ^{j}=½, i=1,2. Finally, assume that [symbol] (A)≡ [symbol] where [symbol] ε(0,1) is a constant.

In this example, there are three types of terminal regions:
1. A contains no observation. In this case, Φ(A)=1.
2. A is a single cell (in the 2^{p} table) containing any number of observations. In this case, Φ(A)=1.
3. A contains exactly one observation and A is a region where M of the p variables are still available for splitting. In this case,

Φ(A)=r_{M}=∫q(x)dπ_{M}(Q)

where π_{M}(•) is the optional Pólya tree on a 2^{M} table. By recursion of Equation 3, we have

$$\begin{matrix}{r}_{M} = ϱ {2}^{- M} + ( 1 - ϱ ) ( 1 / M {\sum }_{j = 1}^{M} B ( 32 , 12 ) / B ( 12 , 12 ) ) \cdot {r}_{M - 1} \\ = ϱ {2}^{- M} + ( 1 - ϱ ) 12 {r}_{M - 1} \\ = ϱ {2}^{- M} ( 1 - {( 1 - ϱ )}^{M} ) / 1 - ( 1 - ϱ ) + {( 1 - ϱ / 2 )}^{M} \\ = {2}^{- M} .\end{matrix}$$

In Example 4, Ω is a bounded rectangle in R^{p} with a partitioning scheme as in Example 2. Assume that for each region, one of the p variables is chosen to split it (λⱼ≡1/p), and that αᵢ^{j}=12, i=1,2. Assume [symbol] (A) is a constant, [symbol] ε(0,1). In this case, a terminal region A contains either no observations (then Φ(A)=1) or a single observation xεA. In the latter case,

Φ(A)=r_{A}(x)=∫_{A}q(x|A)dπ_{A}(Q)

and

$$\begin{matrix}{r}_{A} ( x ) = ϱ / μ ( A ) + ( 1 - ϱ ) 1 / p {\sum }_{j = 1}^{p} B ( 32 , 12 ) / B ( 12 , 12 ) \cdot {r}_{{A}_{i} ( x )}^{j} ( x ) \\ = ϱ / μ ( A ) + ( 1 - ϱ ) 12 {r}_{{A}_{i} ( x )}^{j} ( x )\end{matrix}$$

where i(x)=1 or 2 according to whether xεA₁^{j} or A₂^{j}. Since μ(A₁^{j})=μ(A₂^{j})=½μ(A) for the Lebesgue measure, we have

$$\begin{matrix}{r}_{A} ( x ) = ϱ / μ ( A ) + ( 1 - ϱ ) 1 / 2 [ ϱ / μ ( A ) \cdot 12 + ( 1 - ϱ ) 12 [ … ] ] \\ = ϱ / μ ( A ) [ 1 + ( 1 - ϱ ) + {( 1 - ϱ )}^{2} + … ] \\ = 1 / μ ( A ) .\end{matrix}$$

In the following Example 5, Ω is a bounded rectangle in R^{p}. At each level, we split the regions according to just one coordinate variable, according to a predetermined order, e.g., coordinate variable xᵢ is used to split all regions at the kth step whenever k≡i (mod p). In this case, Φ(A) for terminal regions are determined exactly as in Example 4. By allowing only one way to split a region, we sacrifice some flexibility in the resulting partition in exchange for a great reduction of computational complexity.

The next result shows that optional Pólya tree priors lead to posterior distributions that are consistent in the weak topology. For any probability measure Q₀ on Ω, a weak neighborhood U of Q₀ is a set of probability measures of the form

U=:|∫gᵢ(•)dQ−∫gᵢ(•)dQ₀|<∈ᵢ, i=1, 2, . . . , K}

where gᵢ(•) is a bounded continuous function on Ω.

Theorem 4 is now considered. Let x₁, x₂, . . . be independent, identically distributed variables from a probability measure Q, π(•) and π(•|x₁, . . . , xₙ) be the prior and posterior distributions for Q as defined in Theorem 3. Then, for any Q₀ with a bounded density, it holds with Q₀^{(∞)} probability equal to 1 that

π(U|x₁, . . . , xₙ)→1

for all weak neighborhoods U of Q₀.

The proof of Theorem 4 follows. It is a consequence of Schwartz's theorem [Schw65] that the posterior is weakly consistent if the prior has positive probability in Kullback-Leibler neighborhoods of the true density [Ghosh03]. Thus, by the same argument as in Theorem 4, it is only necessary to show that it is possible to approximate a bounded density in Kullback-Leibler distance by step functions on a suitably refined partition.

Let ƒ be a density satisfying sup_{xεΩ}ƒ(x)≦M<μ. First assume that ƒ is continuous with modulus of continuity δ(∈). Let ∪ᵢ₌₁^{I}Aᵢ be a recursive partition of Ω satisfying Aᵢε [symbol] ^{k} and diameter (Aᵢ)≦∈. Let

gᵢ=sup_{xεAi}ƒ(x),g(x)=Σᵢ₌₁^{I}gᵢI_{Ai}(x)

and G=∫g(x)dμ. It is asserted that as ∈→0, the density g/G approximates ƒ arbitrarily well in Kullback-Leibler distance. To see this, note that

$$\begin{matrix}0 \leq G - 1 = \int ( g - f ) d μ \\ = {\sum }_{i} {\int }_{{A}_{i}} ( g ( x ) - f ( x ) ) d μ \leq {\sum }_{i} {\int }_{{A}_{i}} δ ( ɛ ) d μ \\ = δ ( ɛ ) μ ( Ω ) .\end{matrix}$$

### Hence

$$0 \leq \int f log ( f / ( g / G ) ) d μ = \int f log ( f / g ) d μ + \int f log G d μ \leq log ( G ) \leq log ( 1 + δ ( ɛ ) μ ( Ω ) ) .$$

Finally, if ƒ is not continuous, we can find a set B⊂Ω with μ(B^{c})<∈′ such that ƒ is uniformly continuous on B. Then

$$\int ( g - f ) d μ = {\int }_{B} ( g - f ) d μ + {\int }_{{B}^{c}} ( g - f ) d μ \leq δ ( ɛ ) μ ( Ω ) + M {ɛ}^{′}$$

and the result still holds and the proof is complete.

Density estimation using an optional Pólya tree prior is now considered. In this discussion, the methods for density estimation using an optional Pólya tree prior will be developed and tested. Two different strategies are considered. The first is through computing the posterior mean density. The other is a two-stage approach—first learn a fixed tree topology that is representative of the underlying structure of the distribution, and then compute a piecewise constant estimate conditional on this tree topology.

Numerical examples start with the 1-dimensional setting to demonstrate some of the basic properties of optional Pólya trees. Examples then move onto the 2-dimensional setting to provide a sense of what happens when the dimensionality of the distribution increases.

For demonstration purpose, consider first the situation described in Example 2 with p=1, where the state space is the unit interval and the splitting point of each elementary region (or tree node) is the middle point of its range. In this simple scenario, each node has only one way to divide, and so the only decision to make is whether to stop or not. Each point x in the state space Ω belongs to one and only one elementary region in A^{k} for each k. In this case, the posterior mean density function can be computed very efficiently using an inductive procedure. So as not to detract from the present discussion further detail on this procedure is provided further below.

In a multi-dimensional setting with multiple ways to split at each node, the sets in each A^{k} could overlap, and so the computation of the posterior mean is more difficult. One way to get around this problem is to place some restriction on how the elementary regions can split. For example, an alternate splitting rule requires that each dimension is split in turn (Example 5). This limits the number of choices to split for each elementary region to one and effectively reduces the dimensionality of the problem to one. However, in restricting the ways to divide, a lot of computation is expended on cutting dimensions that need not be cut, which affects the variability of the estimate significantly. This phenomenon is demonstrated in later examples.

Another way to compute (or at least approximate) the posterior mean density is explored by Hutter [Hutter09]. For any point xεΩ, Hutter proposed computing Φ(Ω|x,D), and using Φ(Ω|x,D)/Φ(Ω|D) as an estimate of the posterior mean density at x. (Here D represents the observed data; Φ(Ω|D) denotes the Φ computed for the root node given the observed data points, and Φ(Ω|x,D) is computed treating x as an extra data point observed.) This method is general but computationally intensive, especially when there are multiple ways to divide each node. Also, because this method is for estimating the density at a specific point, to investigate the entire function one must evaluate Φ(Ω|x,D) on a grid of x values, which makes it even more unattractive computationally. For this reason, in the later 2-dimensional examples, only the restriction method discussed above to compute the posterior mean is used.

Another approach for density estimation using an optional Pólya tree prior is to proceed in two steps—first learn a “good” partition or tree topology over the state space, and then estimate the density conditional on this tree topology. The first step reduces the prior process from an infinite mixture of infinite trees to a fixed finite tree. Given such a fixed tree topology (i.e., whether to stop or not at each step, and if not which way to divide), the (conditional) mean density function is computed. The posterior probability mass over each node is simply a product of Beta means, and the distribution within those stopped regions is uniform by construction.

So the key lies in learning a reliable tree structure. In fact, learning the tree topology is useful beyond facilitating density estimation. A representative partition over the state space by itself sheds light on the underlying structure of the distribution. Such information is particularly valuable in high dimensional problems where direct visualization of the data is difficult.

Because a tree topology depends only on the decisions to stop and the ways to split, its posterior probability is determined by the posterior [symbol] 's and λ's. The likelihood of each fixed tree topology is the product of a sequence of terms in the form, [symbol] , 1− [symbol] , λₖ, depending on the stopping and splitting decisions at each node. One candidate tree topology for representing the data structure is the maximum a posteriori (MAP) topology, i.e. the topology with the highest posterior probability. I this setting, however, the MAP topology often does not produce the most descriptive partition for the distribution. It biases toward shorter tree branches in that deeper tree structures simply have more terms less than 1 to multiply into their posterior probability.

While the data typically provide strong evidence for the stopping decisions, (and so the posterior [symbol] 's for all but the very deep nodes are either very close to 1 or very close to 0,) this is not the case for the λ's. It occurs often that for an elementary region the data points are distributed relatively symmetrically in two or more directions, and thus the posterior λ's for those directions will be much less than 1. As a consequence, deep tree topologies, even if they reflect the actual underlying data structure, often have lower posterior probabilities than shallow trees do. This consequence of the MAP estimate relates more generally to the multi-modality of the posterior distribution as well as the self-similarity of the prior process.

In a preferred embodiment, the representative tree topology is constructed through a top-down sequential procedure. Starting from the root node, if the posterior [symbol] >0.5 then the tree is stopped, otherwise the tree is divided in the direction k that has the highest λₖ. When there are more than one direction with the same highest λₖ, the choice among them can be arbitrary. Then this procedure is repeated for each Aₖ^{j} until all branches of the tree have been stopped. This can be viewed as a hierarchical MAP decision procedure—with each MAP decision being made based on those made in the previous steps. In the context of building trees, this approach is natural in that it exploits the hierarchy inherent in the problem.

The optional Pólya tree prior will now be applied to several examples of density estimation in one and two dimensions. The situation described in Example 2 is considered with p=1 and 2, where the state space is the unit interval [0,1] and the unit square [0,1]×[0,1], respectively. The cutting point of each coordinate is the middle point of its range for the corresponding elementary region. For all the optional Pólya tree priors used in the following examples, the prior stopping probability [symbol] =0.5 and the prior pseudo-count α=0.5 for all elementary regions. The standard Pólya tree priors examined (as a comparison) have quadratically increasing pseudo-counts α=depth² (see [Ferg74] and [Kraft64]).

For numerical purpose, dividing the nodes is stopped if their support is under a certain threshold, which is called the precision threshold. A threshold of 10⁻⁶ was used as the precision threshold in the one-dimensional examples and 10⁻⁴ in the two-dimensional examples. Note that in the on-dimensional examples, each node has only one way to divide, and so the inductive procedure described in the Appendix can be used to compute the posterior mean density function. For the two-dimensional examples, the full optional tree as well as a restricted version based on “alternate cutting” (see Example 5) were implemented and tested.

Example 6 considers a mixture of two close spiky uniforms. Data is simulated from the following mixture of uniforms

0.5 U(0.23,0.232)+0.5 U(0.233,0.235),

and three methods to estimate the density function are applied. The first is to compute the posterior mean density using an optional Pólya tree prior. The second is to apply the hierarchical MAP method using an optional Pólya tree prior. The third is to compute the posterior mean using a standard Pólya tree prior.

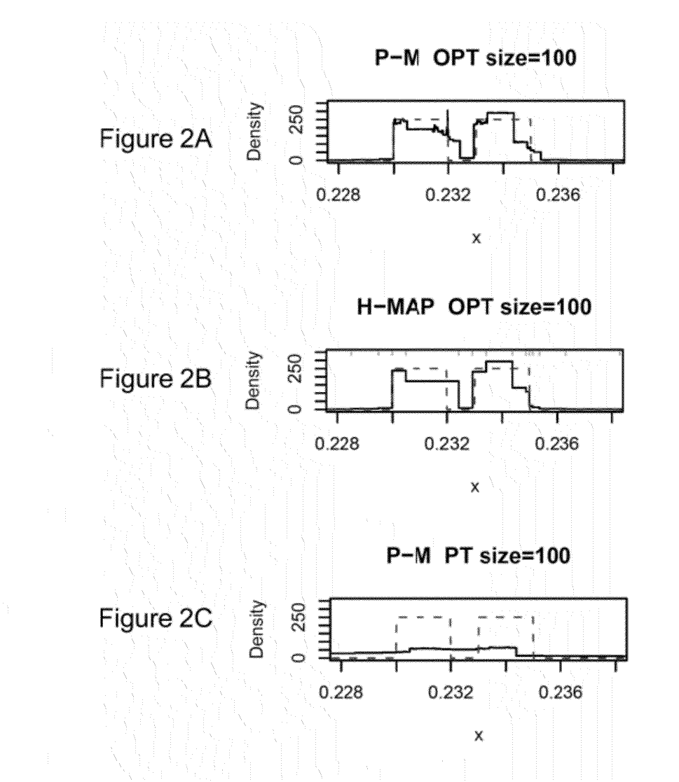

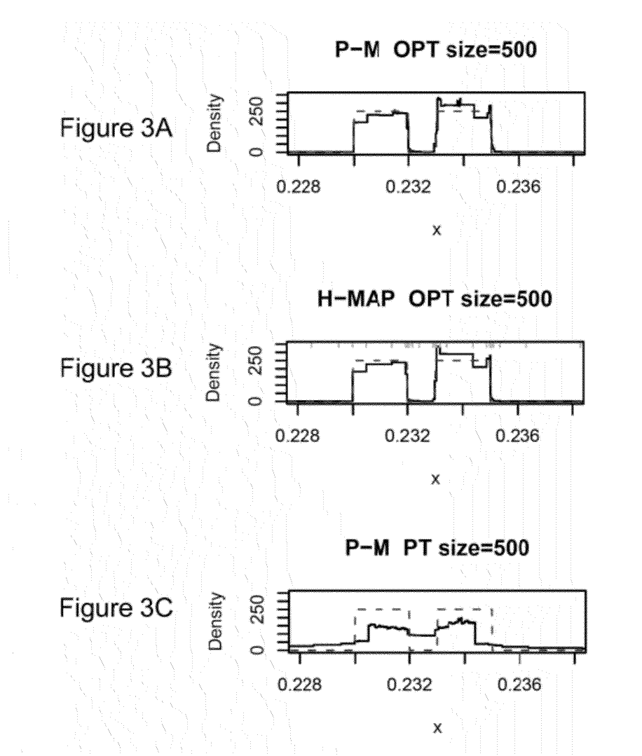

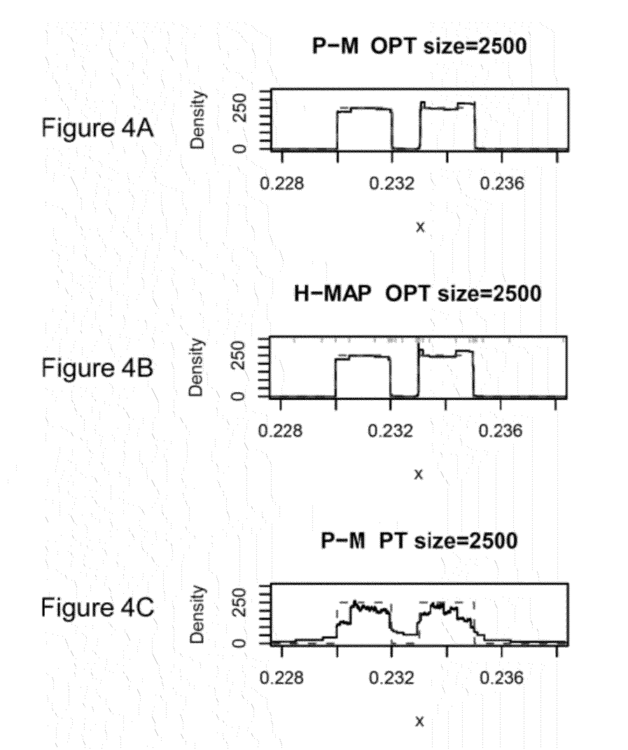

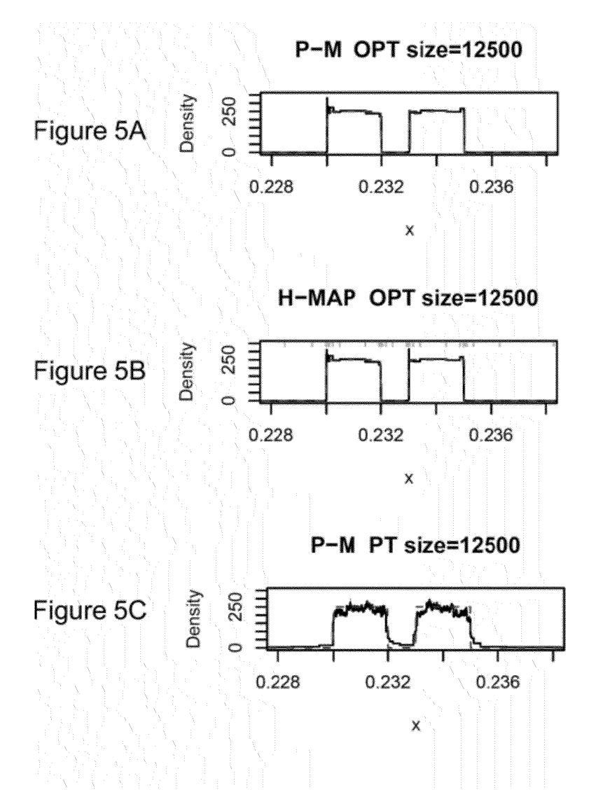

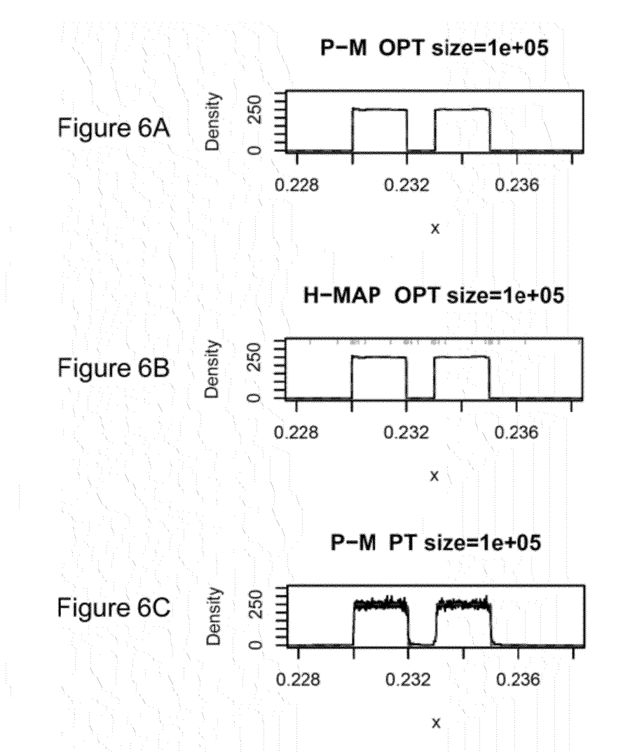

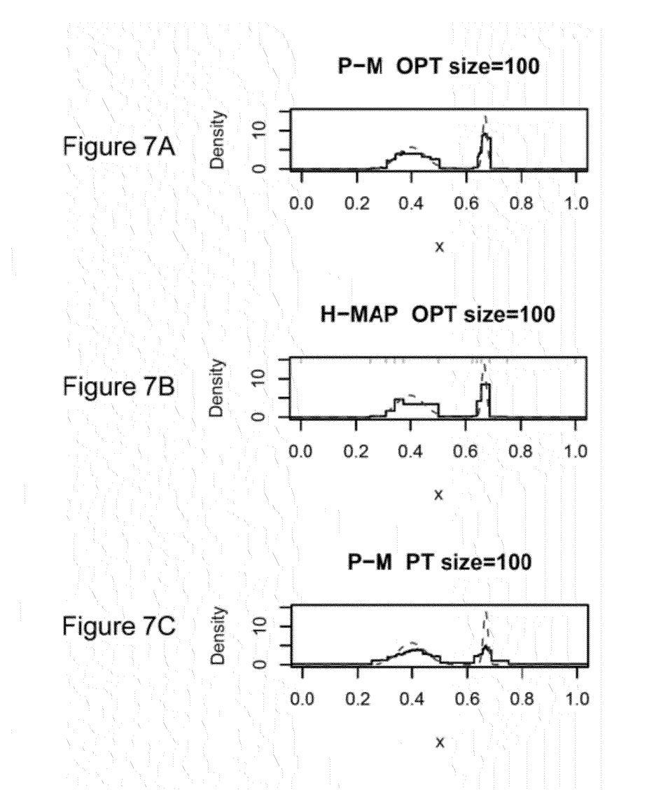

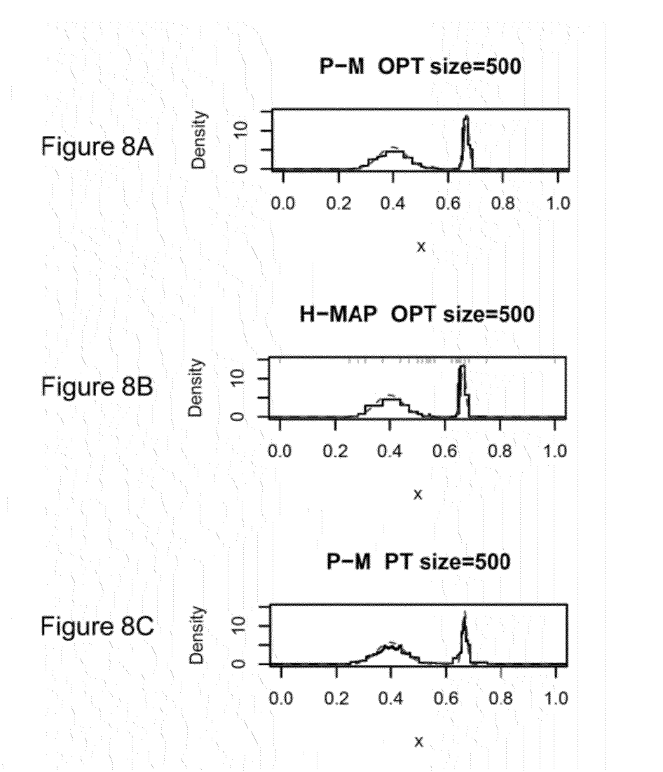

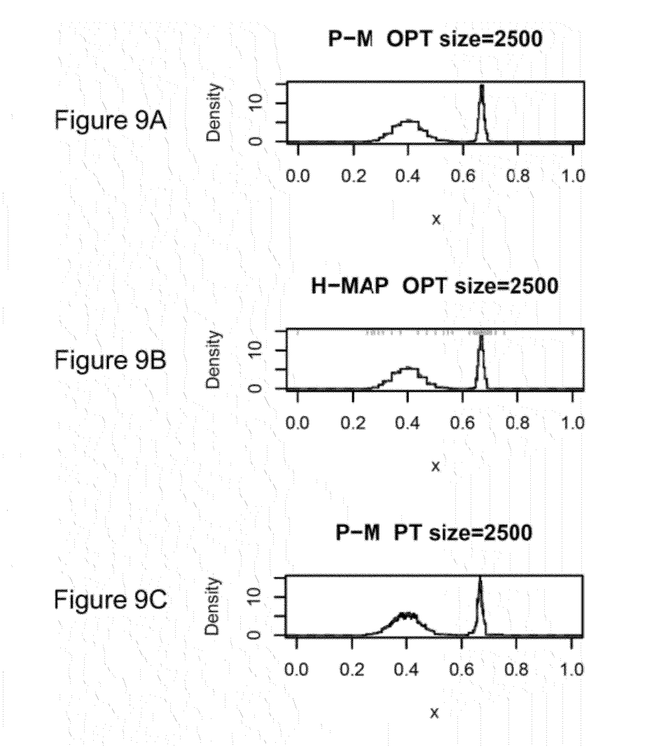

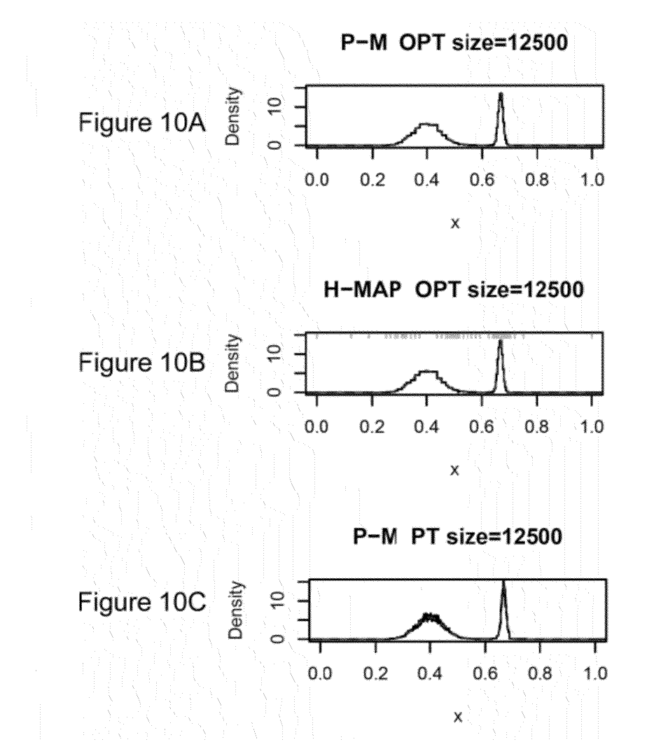

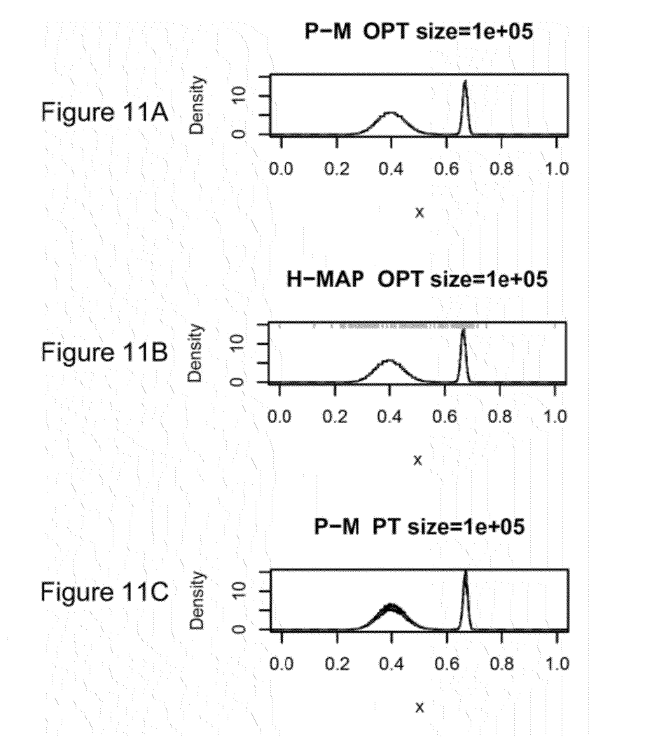

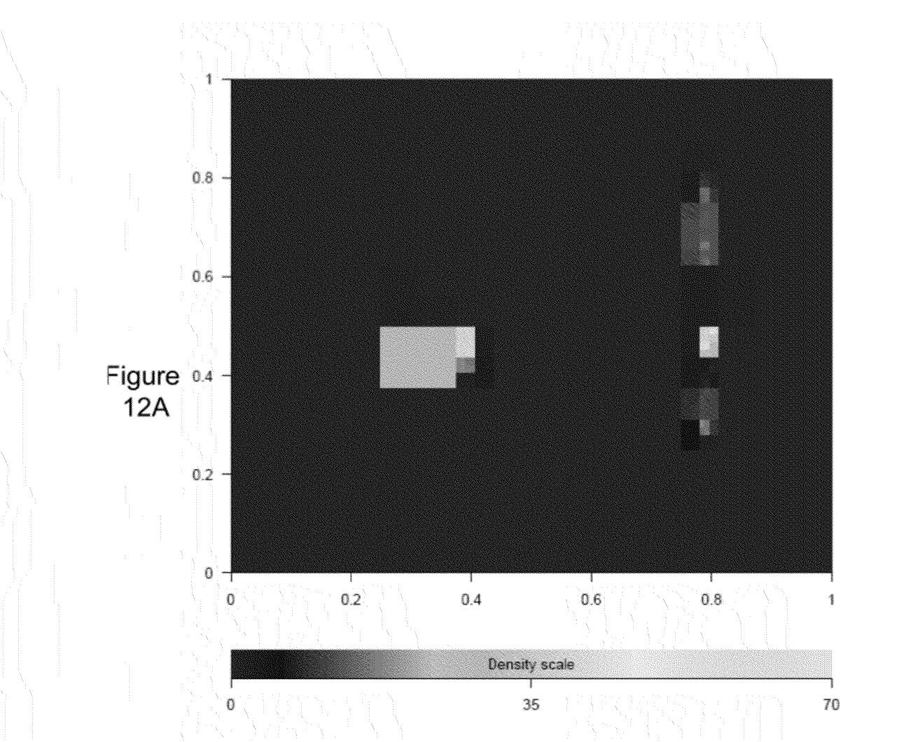

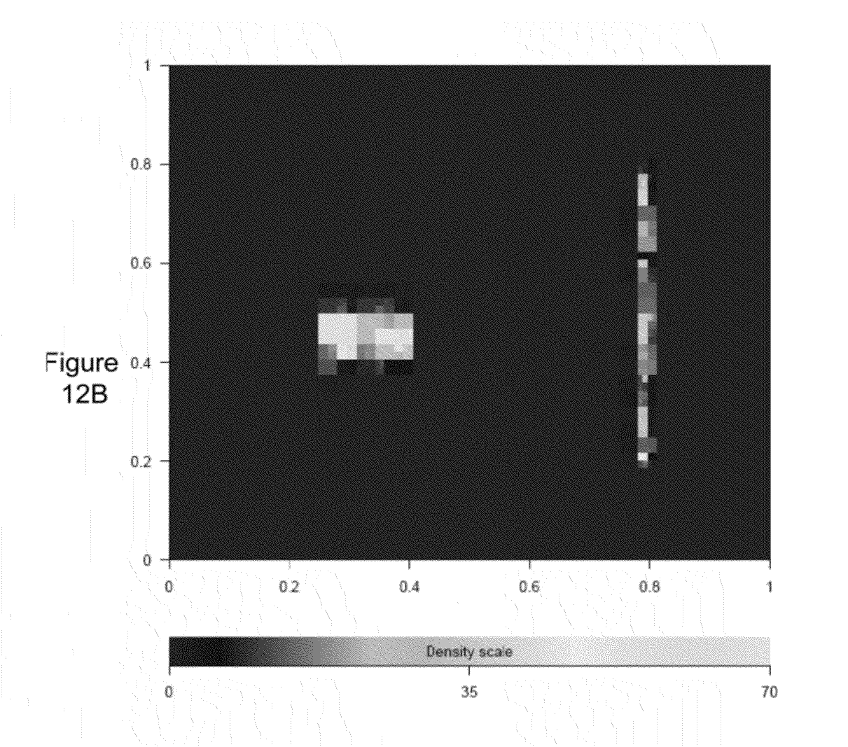

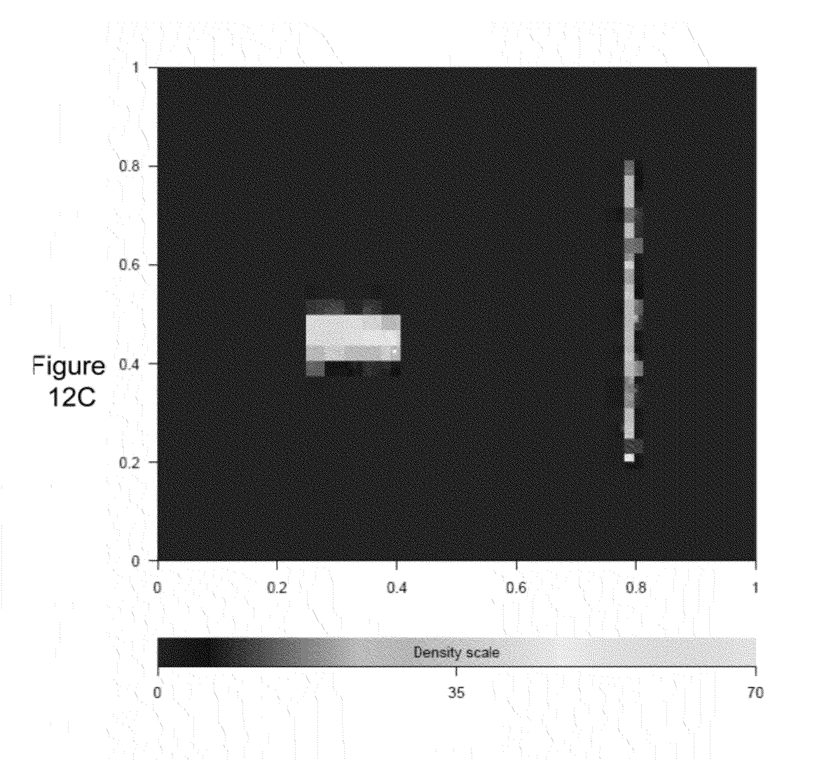

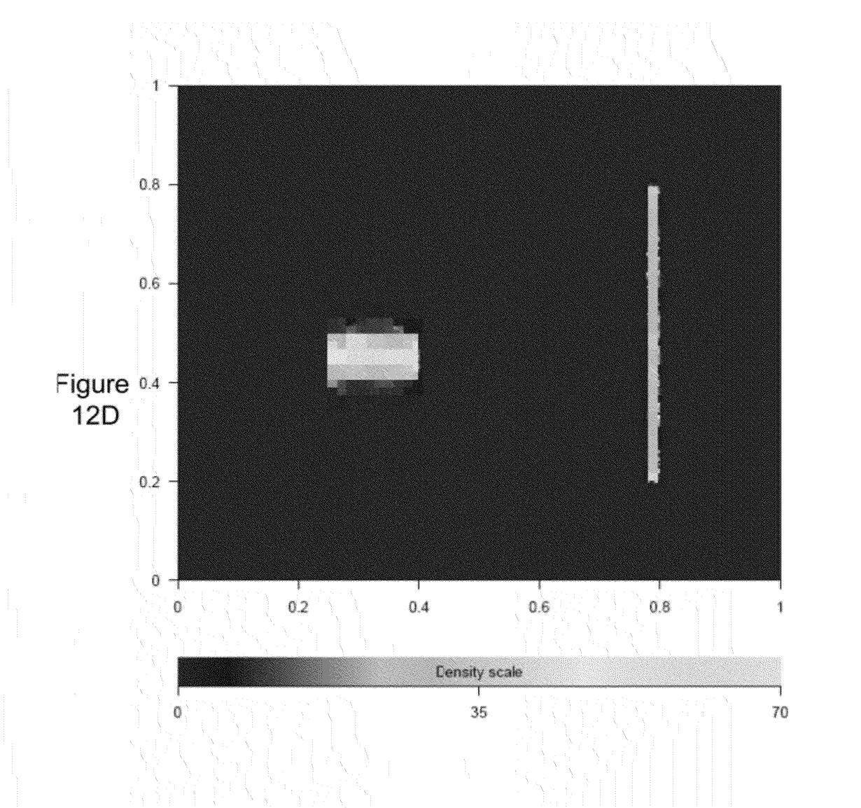

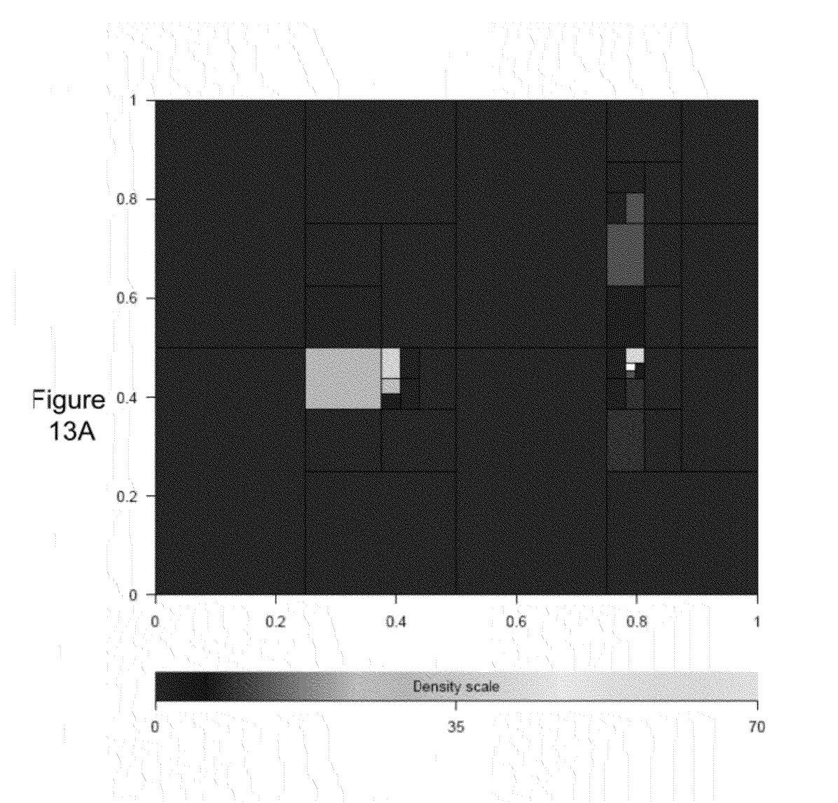

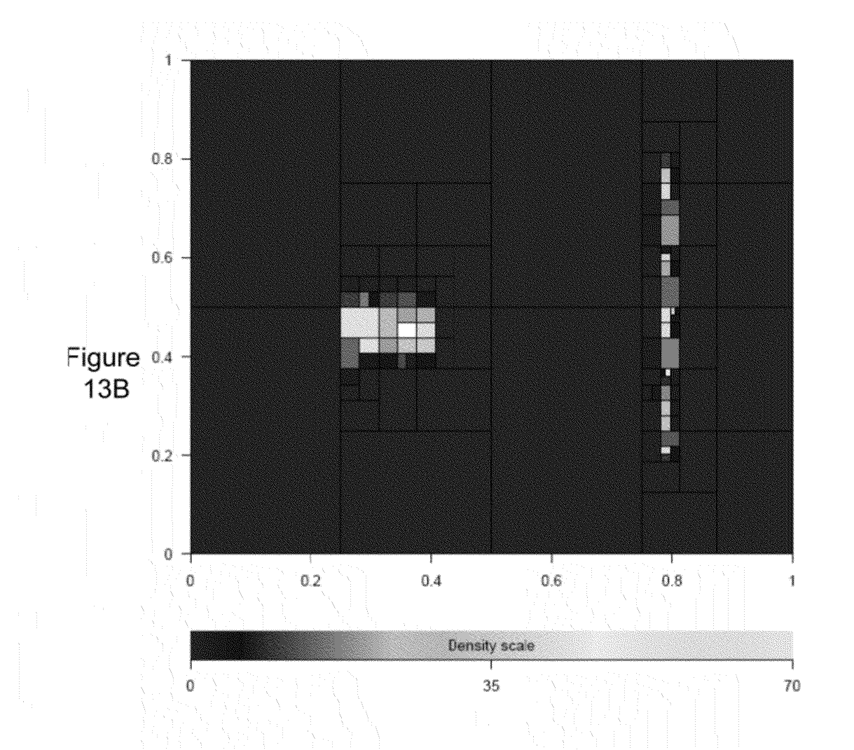

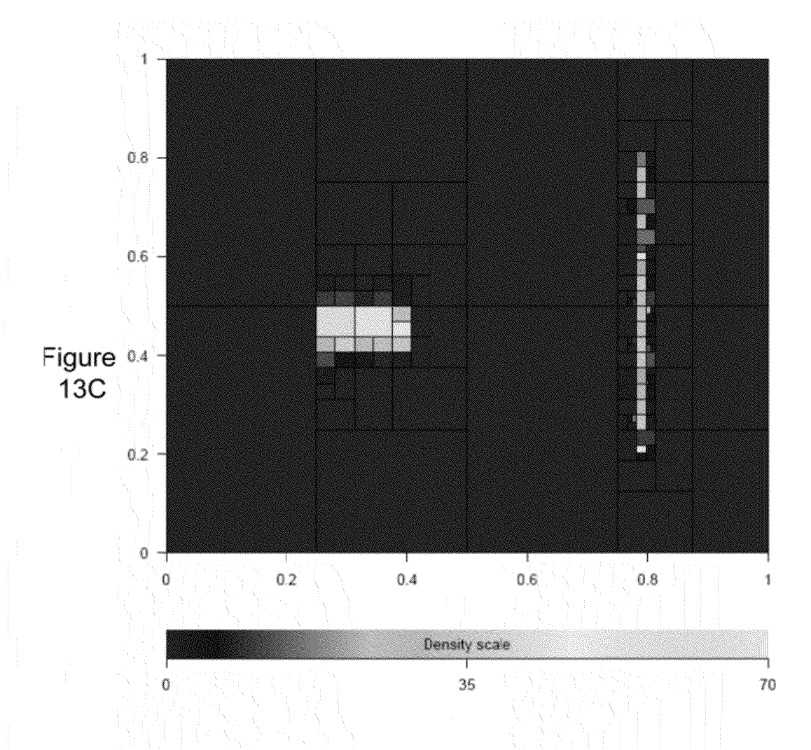

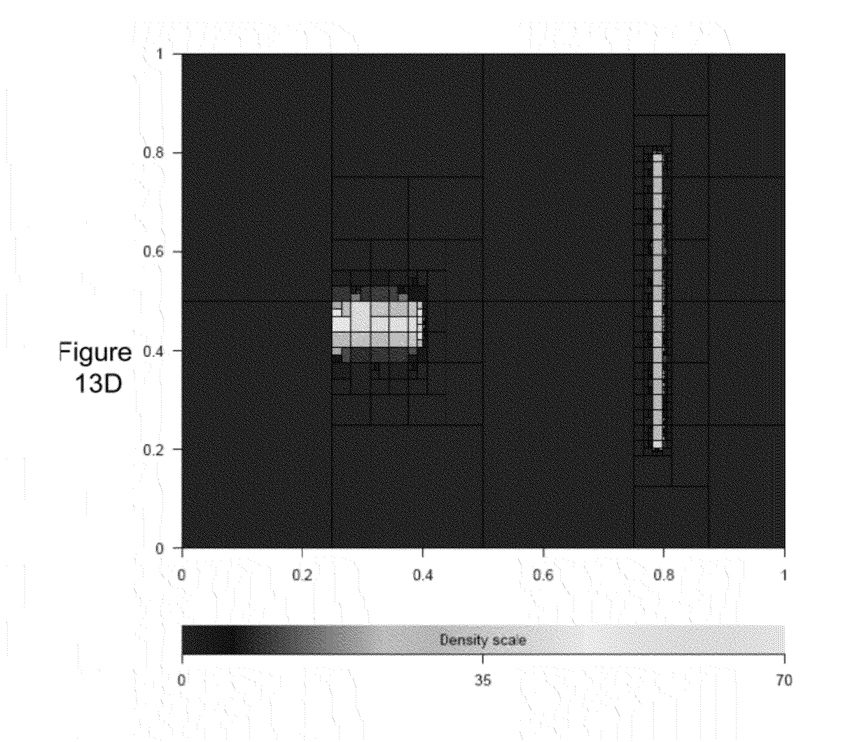

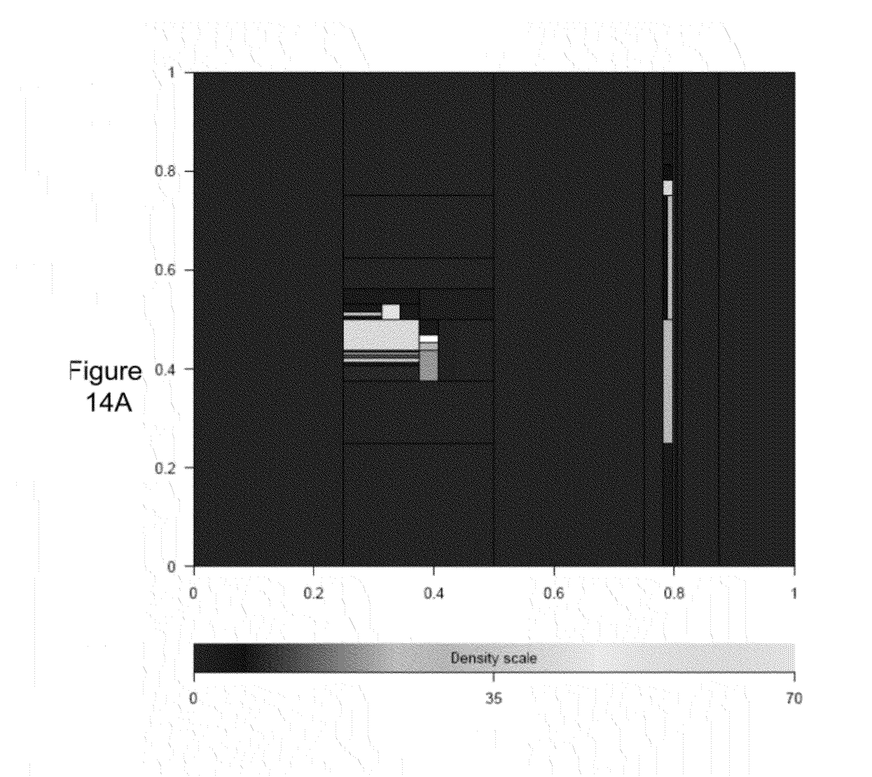

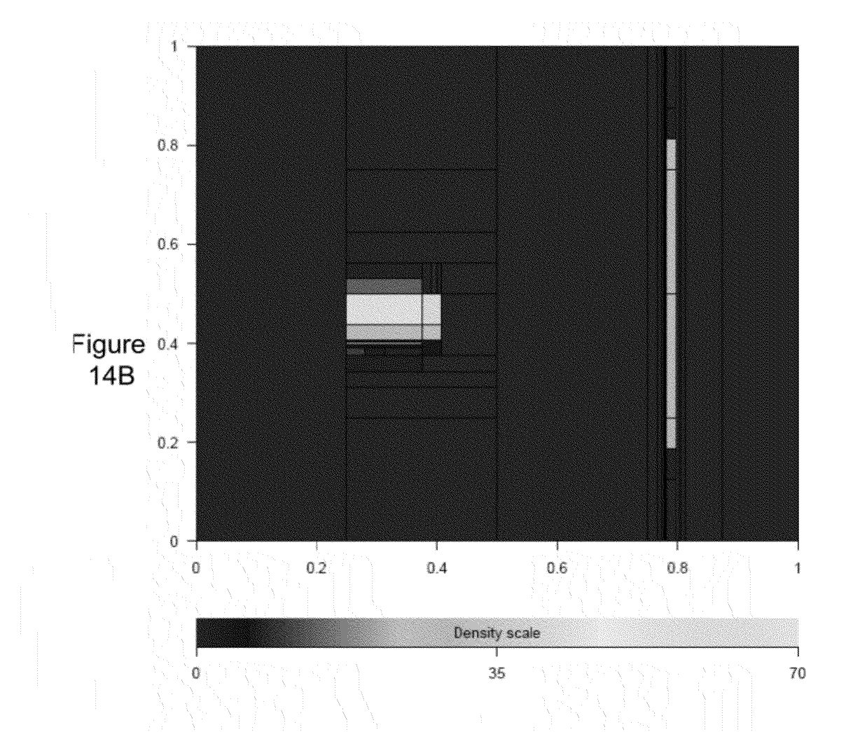

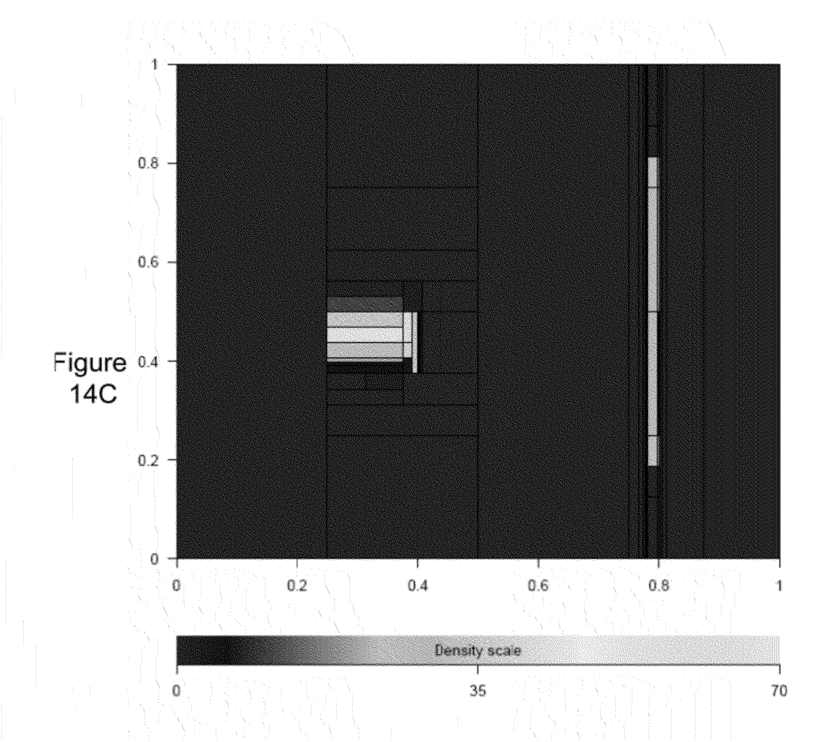

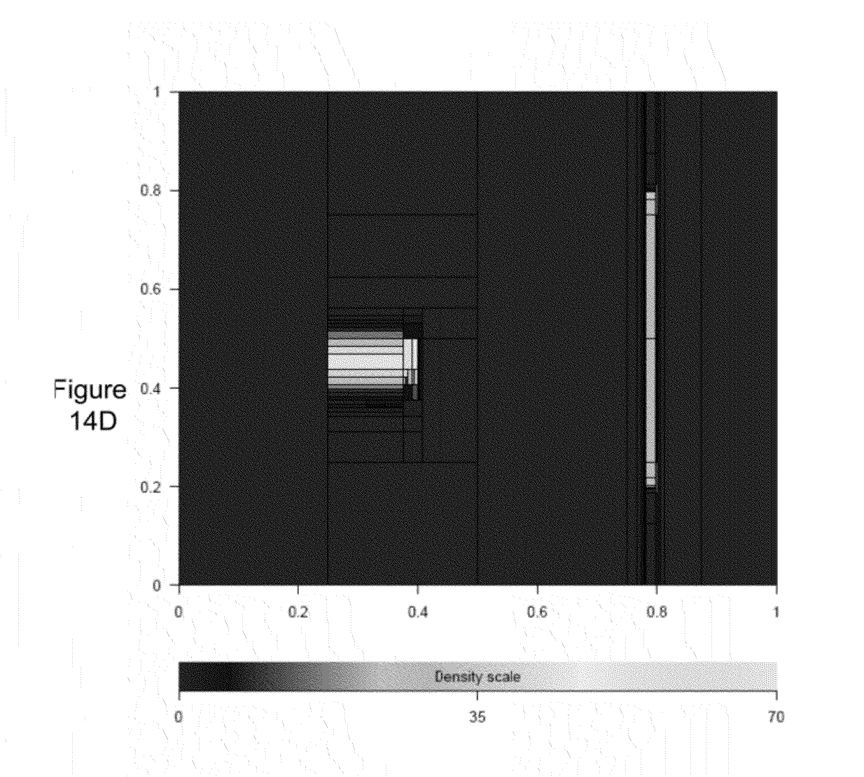

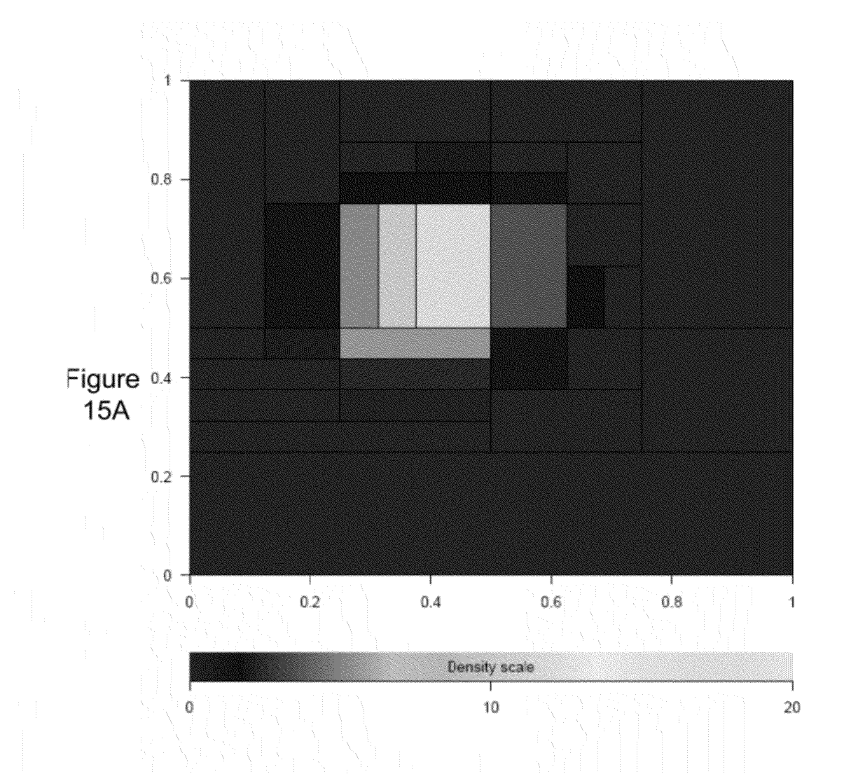

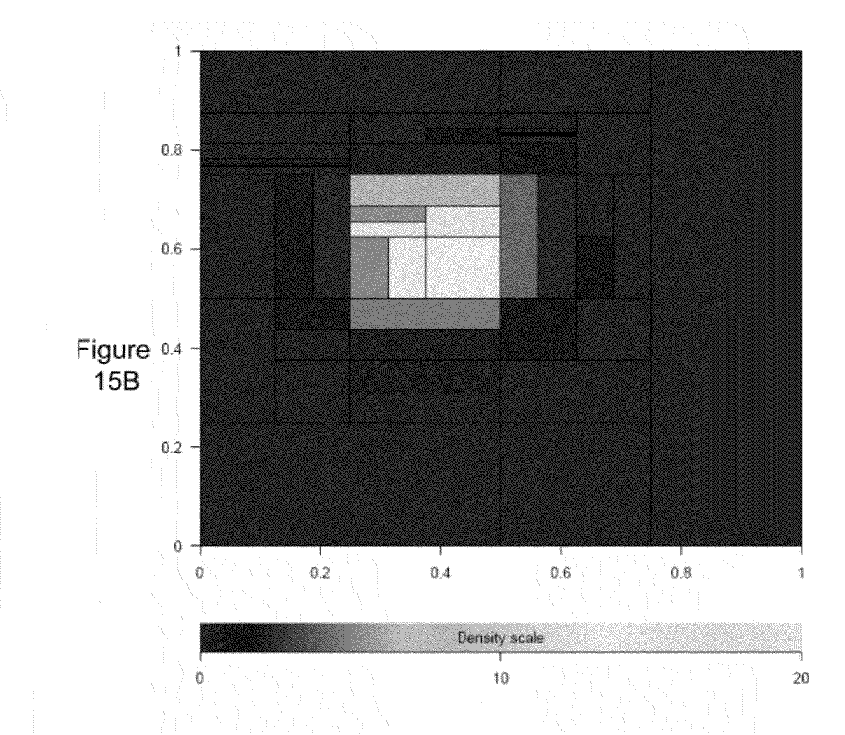

The results for density estimation of this mixture of uniforms are shown in FIGS. 2-6. FIG. 2 represents a sample size of 100, FIG. 3 represents a sample size of 500, FIG. 4 represents a sample size of 2500, FIG. 5 represents a sample size of 12,500, and FIG. 6 represents a sample size of 100,000. Each of FIGS. 2-6 has three graphs (A, B, and C). Graph A corresponds to the posterior mean approach using an optional Pólya tree prior. Graph B corresponds to the hierarchical MAP method using an optional Pólya tree prior. The tick marks on the upper part of Graph C indicate the partitions learned using this method. Graph C corresponds to the posterior mean approach using a standard Pólya tree prior with α=depth². The dashed lines in all the graphs represent the true density function.

Several results from FIGS. 2-6 are notable. First, a sample size of 500 is sufficient for the optional tree methods to capture the boundaries as well as the modes of the uniform distributions, whereas the Pólya tree prior with quadratic pseudo-counts requires thousands of data points to achieve this result. Also, with increasing sample size, the estimates from the optional Pólya tree methods become smoother, while the estimate from the standard Pólya tree with quadratic pseudo-counts is still “locally spiky” even for a sample size of 100,000. This issue can be addressed by increasing the prior pseudo-counts faster than the quadratic rate, at the price of further loss of flexibility. Also, the results shown that the hierarchical MAP method performs just as well as the posterior mean approach even though it requires much less computation and memory. Finally, the partition learned in the hierarchical MAP approach reflects the structure of the distribution.

Example 7 considers a mixture of two Betas. The same three methods are applied to simulated samples from a mixture of two Beta distributions,

0.7 Beta(40,60)+0.3 Beta(2000,1000).

The results for density estimation of this example are shown in FIGS. 7-11. FIG. 7 represents a sample size of 100, FIG. 8 represents a sample size of 500, FIG. 9 represents a sample size of 2500, FIG. 10 represents a sample size of 12,500, and FIG. 11 represents a sample size of 100,000. Each of FIGS. 7-11 has three graphs (A, B, and C). Graph A corresponds to the posterior mean approach using an optional Pólya tree prior. Graph B corresponds to the hierarchical MAP method using an optional Pólya tree prior. The tick marks on the upper part of Graph C indicate the partitions learned using this method. Graph C corresponds to the posterior mean approach using a standard Pólya tree prior with α=depth². The dashed lines in all the graphs represent the true density function.

Both the optional and the standard Pólya tree methods do a satisfactory job in capturing the locations of the two mixture components (with smooth boundaries). Indeed, the optional Pólya tree does well with just 100 data points.

Example 8 considers a mixture of uniform and semi-Beta in the unit square, [0,1]×[0,1]. The first component is a uniform distribution over [0.78,0.80]×[0.2,0.8]. The second component has support [0.25,0.4]×[0,1] with X being uniform over [0.25,0.4] and Y being Beta(100, 120), independent of each other. The mixture probability for the two components are (0.35, 0.65). Therefore, the actual density function of the distribution is

0.35/0.012×1_{[0.78,0.80]×[0.2,0.8]}+0.65/0.15×Γ(220)/Γ(120)Γ(100)y⁹⁹(1−y)¹¹⁹1_{[0.25,0.4]×[0,1]}.

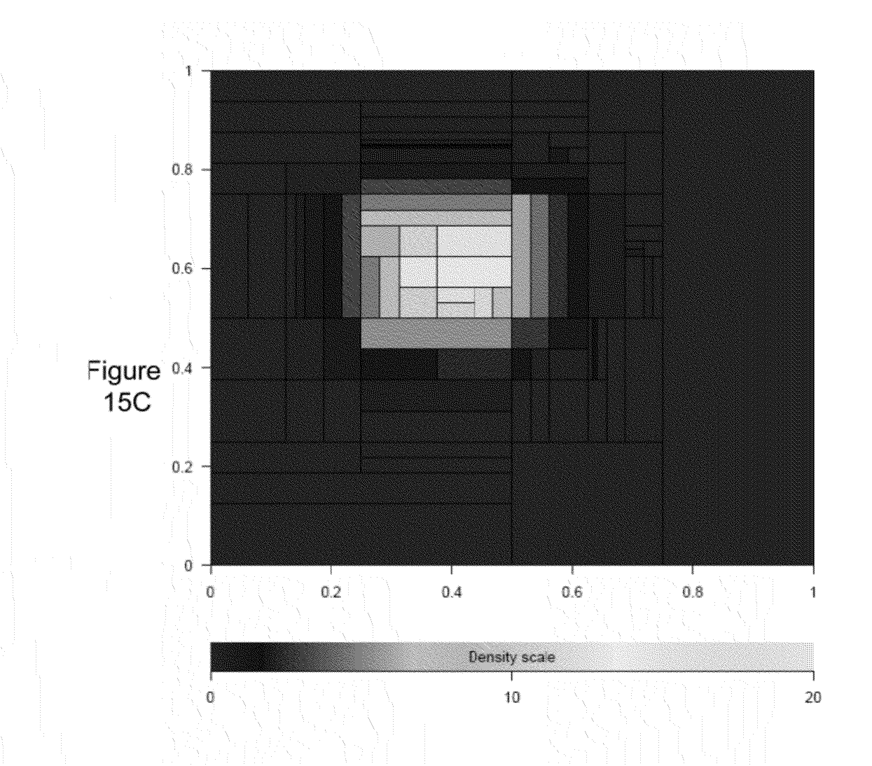

The following methods are applied to estimate this density—(1) the posterior mean approach using an optional Pólya tree prior with the alternate cutting restriction (see FIGS. 12A-D); (2) the hierarchical MAP method using an optional Pólya tree prior with the alternate cutting restriction (see FIGS. 13A-D); and (3) the hierarchical MAP method using an optional Pólya tree prior without any restriction on division (see FIGS. 14A-D).

Shown in FIGS. 12A-D are the density estimates for a mixture of uniform and “semi-Beta” using the posterior mean approach for an optional Pólya tree with the restriction of “alternate cutting” and using a sample size of 100, 500, 1000, and 5000, respectively. The white blocks represent the density estimates falling outside of the plotted intensity range.

Shown in FIGS. 13A-D are the density estimates for a mixture of uniform and “semi-Beta” by the hierarchical MAP method using the posterior mean approach for an optional Pólya tree with the restriction of “alternate cutting” and using a sample size of 100, 500, 1000, and 5000, respectively. The dark lines mark the representative partition learned from the method. The white blocks represent the density estimates falling outside of the plotted intensity range.

Shown in FIGS. 14A-D are the density estimates for a mixture of uniform and “semi-Beta” by the hierarchical MAP method using an optional Pólya tree prior with no restriction on division and using a sample size of 100, 500, 1000, and 5000, respectively. The dark lines mark the representative partition learned from the method. The white blocks represent the density estimates falling outside of the plotted intensity range.

The last method does a much better job in capturing the underlying structure of the data, and thus requires a much smaller sample size to achieve satisfactory estimates of the density.

In the last example (Example 9), the hierarchical MAP method is applied using an optional Pólya tree prior to samples from a bivariate normal distribution

$$BN ( ( \begin{matrix}0.6 \\ 0.4\end{matrix} ) , ( \begin{matrix}{0.1}^{2} & 0 \\ 0 & {0.1}^{2}\end{matrix} ) )$$

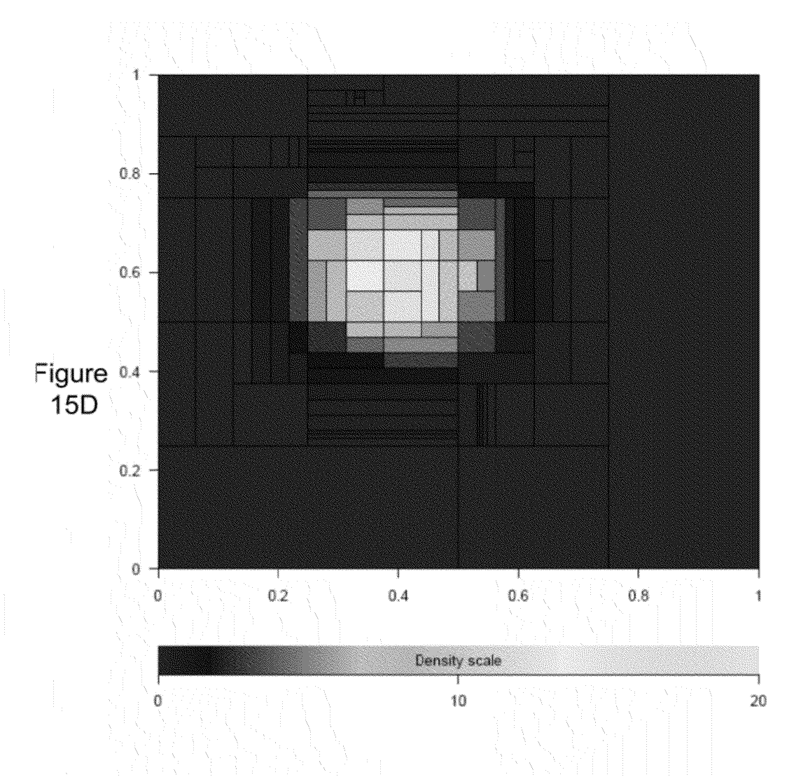

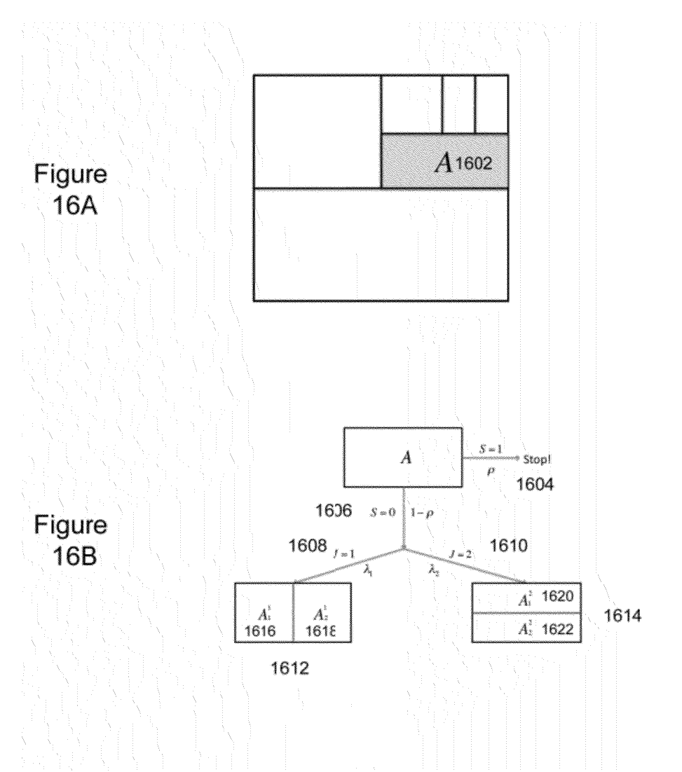

This example demonstrates how the posterior optional Pólya tree behaves in a multi-dimensional setting when the underlying distribution has smooth boundary (see FIGS. 15A-D).

Shown in FIGS. 15A-D are the density estimates for a mixture of uniform and “semi-Beta” by the hierarchical MAP method using an optional Pólya tree prior applied to samples from a bivariate normal distribution BN((0.4, 0.6), 0.1²I) and using a sample size of 500, 1000, 5000, and 10,000, respectively. The dark lines mark the representative partition learned from the method. The white blocks represent the density estimates falling outside of the plotted intensity range.

Not surprisingly, the gradient or change in density is best captured when its direction is perpendicular to one of the coordinates (and thus parallel to the other in the 2D case).

The present disclosure has established the existence and the theoretical properties of continuous probability measures obtained through the introduction of randomized splitting variables and early stopping rules into a Pólya tree construction. For low dimensional densities, it is possible to carry out exact computation to obtain posterior inferences based on this “optional Pólya tree” prior. A conceptually important feature of this approach is the ability to learn the partition underlying a piecewise constant density in a principled manner. Although the present invention was motivated by applications in high-dimensional problems, computation can be demanding for such applications.

Above, an inductive procedure for computing the mean density function of an optional Pólya tree when the way to divide each elementary region is dichotomous and unique was mentioned. More detail is provided here.

Let Aᵢ denote a level-i elementary region, and (k₁,k₂, . . . , kᵢ) the sequence of left and right decisions to reach Aᵢ from the root node Ω. That is, Aᵢ=Ω_{k1k2 . . . ki}, where the k's take values in {0, 1} indicating left and right, respectively. For simplicity, let A₀=Ω represent the root node. Now, for any point xεΩ, let {Aᵢ} be the sequence of nodes such that xε∪ᵢ₌₀^{∞}Aᵢ. Assuming μ(Aᵢ)↓0, the density of the mean distribution at x is given by

lim_{i→∞}EP(XεAᵢ)/μ(Aᵢ).

Therefore, to compute the mean density, a recipe for computing EP(XεAᵢ) for any elementary region Aᵢ is needed. To achieve this goal, first let Aᵢ′ be the sibling of Aᵢ for all i≦1. That is,

Aᵢ′=Ω_{k′1k′2 . . . k′i}, where k′ⱼ=kⱼ for j=1, 2, . . . , i−1, and k′ᵢ=1−kᵢ.

Next, for i≦1, let αᵢ and αᵢ′ be the Beta parameters for node Aᵢ₋₁ associated with its two children Aᵢ and Aᵢ′. Also, for i>0, let [symbol] ᵢ be the stopping probability of Aᵢ, and Sᵢ the event that the tree has stopped growing on or before reaching node Aᵢ. With these notations, we have for all i>1,

$$\begin{matrix}\begin{matrix}EP ( X ∈ {A}_{i} ) 1 ( {S}_{i} ) = EP ( X ∈ {A}_{i} ) 1 ( {S}_{i - 1} ) + EP ( X ∈ {A}_{i} ) 1 ( {S}_{i - 1}^{c} ) 1 ( {S}_{i} ) \\ = μ ( {A}_{i} ) / μ ( {A}_{i - 1} ) EP ( X ∈ {A}_{i - 1} ) 1 ( {S}_{i - 1} ) + {α}_{i} / {α}_{i} + \\ {α}_{i}^{′} {ϱ}_{i} EP ( X ∈ {A}_{i - 1} ) 1 ( {S}_{i - 1}^{c} ) ,\end{matrix} \\ and \\ \begin{matrix}EP ( X ∈ {A}_{i} ) 1 ( {S}_{i}^{c} ) = EP ( X ∈ {A}^{i} ) 1 ( {S}_{i}^{c} ) 1 ( {S}_{i - 1}^{c} ) \\ = {α}_{i} / {α}_{i} + {α}_{i}^{′} ( 1 - {ϱ}_{i} ) EP ( X ∈ {A}_{i - 1} ) 1 ( {S}_{i - 1}^{c} ) .\end{matrix}\end{matrix}$$

Now let aᵢ=EP(XεAᵢ)1(Sᵢ) and bᵢ=EP(XεAᵢ)1(Sᵢ^{c}), then the above equations can be rewritten as

$$\{ \begin{matrix}{a}_{i} = \frac{μ ( {A}_{i} )}{μ ( {A}_{i - 1} )} {a}_{i - 1} + \frac{{α}_{i}}{{α}_{i} + {α}_{i}^{′}} {ρ}_{i} {b}_{i - 1} , \\ {b}_{i} = \frac{{α}_{i}}{{α}_{i} + {α}_{i}^{′}} ( 1 - {ρ}_{i} ) {b}_{i - 1} ,\end{matrix} \qquad ( Equation A .1 )$$

{\a\al\co1(aᵢ=μ(Aᵢ)/μ(Aᵢ₋₁)a₁₋₁+αᵢ/αᵢ+αᵢ′ [symbol] ᵢbᵢ₋₁,,,bᵢ=αᵢ/αᵢ+αᵢ′(1− [symbol] ₁)bᵢ₋₁,). (XX)

for all i≧1. Because aₒ=EP(XεΩ)1(S₀)=P(S₀)= [symbol] ₀, and b₀=1−a₀=1 [symbol] ₀, Equation A.1 can be inductively applied to compute the aᵢ and bᵢ for all Aᵢ's. Because EP(XεAᵢ)=aᵢ+bᵢ, the mean density at x is given by

lim_{i→∞}EP(XεAᵢ)/μ(Aᵢ)=lim_{i→∞}(aᵢ+bᵢ)/μ(Aᵢ).

The following documents have been referenced in the present disclosure and are herein incorporated by reference for all purposes.
[Black73] BLACKWELL, D. (1973). Discreteness of Ferguson selections. Ann. Statist. 1 356-358. MR0348905
[BlackMac73] BLACKWELL, D. and MACQUEEN, J. B. (1973). Ferguson distributions via Pólya urn schemes. Ann. Statist. 1 353-355. MR0362614
[Brei84] BREIMAN, L., FRIEDMAN, J. H., OLSHEN, R. A. and STONE, C. J. (1984). Classification and Regression Trees. Wadsworth Advanced Books and Software, Belmont, Calif. MR0726392
[Denison98] DENISON, D. G. T., MALLICK, B. K. and SMITH, A. F. M. (1998). A Bayesian CART algorithm. Biometrika 85 363-377. MR1649118
[Dia86] DIACONIS, P. and FREEDMAN, D. (1986). On inconsistent Bayes estimates of location. Ann. Statist. 14 68-87. MR0829556
[Fabius64] FABIUS, J. (1964). Asymptotic behavior of Bayes' estimates. Ann. Math. Statist. 35 846-856. MR0162325
[Ferg73] FERGUSON, T. S. (1973). A Bayesian analysis of some nonparametric problems. Ann. Statist. 1 209-230. MR0350949
[Ferg74] FERGUSON, T. S. (1974). Prior distributions on spaces of probability measures. Ann. Statist. 2 615-629. MR0438568
[Free63] FREEDMAN, D. A. (1963). On the asymptotic behavior of Bayes' estimates in the discrete case. Ann. Math. Statist. 34 1386-1403. MR0158483
[Ghosh03] GHOSH, J. K. and RAMAMOORTHI, R. V. (2003). Bayesian Nonparametrics. Springer, N.Y. MR1992245
[Hans06] HANSON, T. E. (2006). Inference for mixtures of finite Pólya tree models. J. Amer. Statist. Assoc. 101 1548-1565. MR2279479
[Hutter09] HUTTER, M. (2009). Exact nonparametric Bayesian inference on infinite trees. Technical Report 0903.5342. Available at http://arxiv.org/abs/0903.5342.
[Kraft64] KRAFT, C. H. (1964). A class of distribution function processes which have derivatives. J. Appl. Probab. 1 385-388. MR0171296
[Lav92] LAVINE, M. (1992). Some aspects of Pólya tree distributions for statistical modelling. Ann. Statist. 20 1222-1235. MR1186248
[Lav94] LAVINE, M. (1994). More aspects of Pólya tree distributions for statistical modelling. Ann. Statist. 22 1161-1176. MR1311970
[Lo84] LO, A. Y. (1984). On a class of Bayesian nonparametric estimates. I. Density estimates. Ann. Statist. 12 351-357. MR0733519
[Mau192] MAULDIN, R. D., SUDDERTH, W. D. and WILLIAMS, S.C. (1992). Pólya trees and random distributions. Ann. Statist. 20 1203-1221. MR1186247
[Nie09] NIETO-BARAJAS, L. E. and MÜLLER, P. (2009). Unpublished manuscript.
[Paddock03] PADDOCK, S. M., RUGGERI, F., LAVINE, M. and WEST, M. (2003). Randomized Pólya tree models for nonparametric Bayesian inference. Statist. Sinica 13 443-460. MR1977736
[Schw65] SCHWARTZ, L. (1965). On Bayes procedures. Z. Wahrsch. Verw. Gebiete 4 10-26. MR0184378

It should be appreciated by those skilled in the art that the specific embodiments disclosed above may be readily utilized as a basis for modifying or designing other machine learning techniques for carrying out the same purposes of the present invention. It should also be appreciated by those skilled in the art that such modifications do not depart from the scope of the invention as set forth in the appended claims.

What is claimed is:

1. A method for unsupervised learning comprising:
considering a data set in a predetermined domain for at least one variable;
wherein the data set consists of independent samples from an unknown probability distribution, and wherein the probability distribution is assumed to be generated from a prior distribution on the space of all probability distributions; and
partitioning the domain into sub-regions by a recursive scheme;
assigning probabilities to the sub-regions according to a randomized allocation mechanism;
stopping the partitioning based upon a predetermined condition; and
learning a probability distribution for the data set through a Bayesian inference.

2. The method of claim 1, wherein at least one variable is discrete.

3. The method of claim 1, wherein at least one variable is continuous.

4. The method of claim 1, wherein the predetermined domain is a bounded rectangle.

5. The method of claim 1, wherein the predetermined domain is finite.

6. The method of claim 1, wherein the partitioning step further comprises:
choosing a splitting variable;
partitioning a region of the domain into at least two sub-regions according to the splitting variable.

7. The method of claim 6, wherein the splitting variable is chosen according to a predetermined vector of selection probabilities from one of a set of eligible splitting variables in the region.

8. The method of claim 7, wherein the splitting variable is a continuous variable that is always eligible for further partitioning.

9. The method of claim 7, wherein the splitting variable is a a discrete variable that becomes ineligible for further partitioning when it takes only a single value in a sub-region.

10. The method of claim 1, wherein each region in a current partition is either (i) stopped from being further partitioned, or (ii) further partitioned into smaller sub-regions.

11. The method of claim 10, wherein the stopping decision is made according to an independent variable.

12. The method of claim 10, wherein the independent variable is an independent Bernoulli variable.

13. The method of claim 6, wherein the probability distribution generated from the prior distribution is uniform within each sub-region.

14. The method of claim 6, further comprising assigning probabilities to the sub-regions according to a randomized allocation mechanism.

15. The method of claim 14, wherein the assigning step is performed recursively in parallel with the construction of the said random partition, so that in each step of the recursion,
(i) if a region in the current partition is stopped from further partitioning, then the probability distribution is made uniformly within such region, and
(ii) if the region is further partitioned into one or more sub-regions, then the probability of sub-regions is obtained by multiplying the probability of the parent region with a set of conditional probabilities generated from a predefined Dirichlet distribution.

16. The method of claim 11, wherein the independent variable for a region depends on the probability of the region.

17. A method for unsupervised learning comprising:
considering a data set in a predetermined domain for at least one variable;
wherein the data set consists of independent samples from an unknown probability distribution, and wherein the probability distribution is assumed to be generated from a prior distribution on the space of all probability distributions; and
partitioning the domain into sub-regions by a recursive scheme;
assigning probabilities to the sub-regions according to a randomized allocation mechanism;
stopping the partitioning based upon a predetermined condition; and
learning a probability distribution for the data set based on a posterior distribution on a space of probability distributions through a Bayesian inference.

18. The method of claim 17, wherein at least one variable is discrete.

19. The method of claim 17, wherein at least one variable is continuous.

20. The method of claim 17, wherein the predetermined domain is a bounded rectangle.

21. The method of claim 17, wherein the predetermined domain is finite.

22. The method of claim 17, wherein the partitioning step further comprises:
choosing a splitting variable;
partitioning a region of the domain into at least two sub-regions according to the splitting variable.

23. The method of claim 22, wherein the splitting variable is chosen according to a predetermined vector of selection probabilities from one of a set of eligible splitting variables in the region.

24. The method of claim 23, wherein the splitting variable is a continuous variable that is always eligible for further partitioning.

25. The method of claim 23, wherein the splitting variable is a a discrete variable that becomes ineligible for further partitioning when it takes only a single value in a sub-region.

26. The method of claim 17, wherein each region in a current partition is either (i) stopped from being further partitioned, or (ii) further partitioned into smaller sub-regions.

27. The method of claim 26, wherein the stopping decision is made according to an independent variable.

28. The method of claim 26, wherein the independent variable is an independent Bernoulli variable.

29. The method of claim 22, wherein the probability distribution generated from the prior distribution is uniform within each sub-region.

30. The method of claim 22, further comprising assigning probabilities to the sub-regions according to a randomized allocation mechanism.

31. The method of claim 30, wherein the assigning step is performed recursively in parallel with the construction of the said random partition, so that in each step of the recursion,
(i) if a region in the current partition is stopped from further partitioning, then the probability distribution is made uniformly within such region, and
(ii) if the region is further partitioned into one or more sub-regions, then the probability of sub-regions is obtained by multiplying the probability of the parent region with a set of conditional probabilities generated from a predefined Dirichlet distribution.

32. The method of claim 27, wherein the independent variable for a region depends on the probability of the region with data-dependent parameters.

33. The method of claim 17, wherein the prior distribution is an optional Pólya tree.

34. The method of claim 27, wherein the independent variable is a function of Φ-indexes associated with sub-regions.

35. The method of claim 22, wherein the splitting is a function of Φ-indexes associated with sub-regions.

36. The method of claim 27, wherein the Dirichlet distribution is a function of Φ-indexes associated with sub-regions.

37. The method of claim 34, 35, or 36, wherein the Φ-indexes are determined by a recursion formula as a function of the Φ-indexes of its sub-regions and the number of data points in these sub-regions.

38. The method of claim 37, wherein a computation of the recursive formula is terminated by a predetermined prescribing constant associated with a region with at most one data point.

39. The method of claim 37, further comprising an approximation for the Φ-indexes to a region containing fewer than a predetermined number of data points.

40. The method of claims 8-37, wherein the computation of the recursion formula is terminated early to reduce computation.

41. The method of claim 40, wherein the termination is determined by a predetermined number of maximum steps.
